(19) United States
(12) Patent Application Publication
(10) Pub. No.: US 2014/0280179 A1
(43) Pub. Date: Sep. 18, 2014

(54) System and Apparatus for Information Retrieval

(71) Applicant: Advanced Search Laboratories, lnc., Allen, TX (US)

(72) Inventor: Jason Coleman, Cedar Point, TX (US)

(73) Assignee: Advanced Search Laboratories, lnc., Allen, TX (US)

(21) Appl. No.: 14/209,229

(22) Filed: Mar. 13, 2014

Related U.S. Application Data
(60) Provisional application No. 61/791,867, filed on Mar. 15, 2013.
(60) Provisional application No. 61/792,461, filed on Mar. 15, 2013.
(60) Provisional application No. 61/793,223, filed on Mar. 15, 2013.

(51) Int. Cl. G06F 17/30

(52) U.S. Cl. CPC G06F 17/30424
USPC 707/740

(57) ABSTRACT

Systems and methods are provided for inputting dimensional articulation for search queries and providing multidimensional relevance for artifacts within an information retrieval system. Various examples relate to systems and methods for information retrieval (IR), specifically those used for search engines. These kinds of systems and methods can variously be described as being related to facilitating database searching; facilitating the creation of queries and terms related to database searching; facilitating the understanding of queries, terms and results related to database searching; facilitating the presentation or display of queries, terms and results related to database searching; and facilitating human-machine interaction with queries, terms and results related to database searching.

### CLAIM OF PRIORITY AND CROSS-REFERENCE TO RELATED APPLICATIONS

The present application is related to U.S. Provisional Patent Application No. 61/791,867 filed Mar. 15, 2013, entitled “ASL IP Bundle Updates,” to U.S. Provisional Patent Application No. 61/792,461, filed Mar. 15, 2013, entitled “System and Method for Query and Result Articulation in Information Retrieval System,” and to U.S. Provisional Patent Application No. 61/793,223, filed Mar. 15, 2013, entitled “Database Search Enhancements.” The present application hereby claims priority under 35 U.S.C. §119(e) to U.S. Provisional Patent Application No. 61/791,867, to U.S. Provisional Patent Application No. 61/792,461, and to U.S. Provisional Patent Application No. 61/793,223.

### TECHNICAL FIELD

The field of the invention is information search systems and methods and, more particularly, improved creation, configuration and management of queries and results in the context of information search systems.

### BACKGROUND

Searching for information or specific artifacts that contain information or other resources on the basis of identifying characteristics, whether on the web or on some other electronic device (computer or smartphone for example), is, for most people, a daily activity.

The extension and enhancement of human knowledge and net intelligence fostered by the development and growth of this kind of activity may be rivaled only by the invention of the printing press or of written communication itself. The core processes that make this kind of activity possible are best referred to by the term “Information Retrieval.” Similarly, a large number of people and organizations create, collect, tag and distribute private and public information via social networks. The utility of such systems as information networks operating as objective sources of truth regarding general information is debatable. However, when information residing in these systems is cast as term facet characteristics that transparently expose the source and subjectivity of source, such systems can become powerful resources for profoundly rich and complex apparatuses of extending human intelligence, collective or individual memory, social knowledge, and accessible information. Further, individuals may similarly create, tag, collect and distribute information for personal or shared use in the same manner with similar results and applications.

### SUMMARY

Systems and methods are provided for inputting dimensional articulation for search queries and providing multidimensional relevance for artifacts within an information retrieval system. Various examples relate to systems and methods for information retrieval (IR), specifically those used for search engines. These kinds of systems and methods can variously be described as being related to facilitating database searching; facilitating the creation of queries and terms related to database searching; facilitating the understanding of queries, terms and results related to database searching; facilitating the presentation or display of queries, terms and results related to database searching; and facilitating human-machine interaction with queries, terms and results related to database searching.

In one example, a method includes retrieving, over a network, an artifact. The method also includes collecting, over the network, evidence associated with the artifact. The method also includes selecting an artifact based on relevance to a set of categories based on information contained in the artifact.

The step of selecting an artifact may be at least partially based on relevance to a set of categories based on external links to the artifact. Alternatively, the step of selecting an artifact may be at least partially based on relevance to a set of categories based on category selections made by an objective curator. Alternatively, the step of selecting an artifact may be at least partially based on relevance to a set of categories based on category selections made by a publisher, provider or creator of content. Alternatively, the step of selecting an artifact may be at least partially based on relevance to a set of categories based on information embedded in a document that is hidden during normal usage.

### BRIEF DESCRIPTION OF THE DRAWINGS

The objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a formula in accordance with an example embodiment;

FIG. 2 is a formula in accordance with an example embodiment;

FIG. 3 is a formula in accordance with an example embodiment;

FIG. 4 is a flow chart in accordance with an example embodiment;

FIG. 5 is a flow chart in accordance with an example embodiment;

FIG. 6 is a user interface presentation in accordance with an example embodiment;

FIG. 7 is a user interface presentation in accordance with an example embodiment;

FIG. 8 is a system architecture diagram in accordance with an example embodiment;

FIG. 9 is a flow chart in accordance with an example embodiment;

FIG. 10 is a flow chart in accordance with an example embodiment;

FIG. 11 is a flow chart in accordance with an example embodiment;

FIG. 12 is a flow chart in accordance with an example embodiment; and

FIG. 13 is a screen shot in accordance with the prior art.

FIG. 14 is an illustration of a categorical ontology in accordance with an example embodiment;

FIG. 15 is a user interface presentation in accordance with an example embodiment;

FIG. 16 is a user interface presentation in accordance with an example embodiment;

FIG. 17 is a user interface presentation in accordance with an example embodiment;

FIG. 18 is a user interface presentation in accordance with an example embodiment;

FIG. 19 is a user interface presentation in accordance with an example embodiment;

FIG. 20 is an illustration of a categorical ontology in accordance with an example embodiment;

FIG. 21 is an illustration of a categorical ontology in accordance with an example embodiment;

FIG. 22 is a user interface presentation in accordance with an example embodiment;

FIG. 23 is a user interface presentation in accordance with an example embodiment;

FIG. 24 is a user interface presentation in accordance with an example embodiment;

FIG. 25 is a user interface presentation in accordance with an example embodiment;

FIG. 26 is a user interface presentation in accordance with an example embodiment;

FIG. 27 is a user interface presentation in accordance with an example embodiment;

FIG. 28 is a user interface presentation in accordance with an example embodiment;

FIG. 29 is a user interface presentation in accordance with an example embodiment;

FIG. 30 is a user interface presentation in accordance with an example embodiment;

FIG. 31 is a user interface presentation in accordance with an example embodiment;

FIG. 32 is a user interface presentation in accordance with an example embodiment;

### DETAILED DESCRIPTION

In general, various example embodiments are directed toward improved creation, configuration and management of queries and results in the context of information search systems.

### Interpretation Considerations

When reading this disclosure, one should keep in mind several points. First, the included exemplary embodiments are what the inventor believes to be the best mode for practicing the invention at the time this patent was filed. Thus, since one of ordinary skill in the art may recognize from the included exemplary embodiments that substantially equivalent structures of substantially equivalent acts may be used to achieve the same results in exactly the same way, or to achieve the same results in a not dissimilar way, the relevant exemplary embodiment should not be interpreted as limiting the invention to one embodiment.

Likewise, individual aspects (sometimes called species or implementations) of the inventions are provided as examples, and accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential.

Third, a function or an act should be interpreted as incorporating all modes of doing that function or act, unless otherwise explicitly stated (for example, one recognizes that “tacking” maybe done by nailing, stapling, gluing, hot gunning, riveting, etc., and all other modes of that word and similar words, such as “attaching”).

Fourth, unless explicitly stated otherwise, conjunctive words (such as “or,” “and,” “including,” or “comprising,” for example) should be interpreted in the inclusive, not the exclusive, sense.

Fifth, the words “means” and “step” are provided to facilitate the reader's understanding of the invention and do not mean “means” or “step” as defined in 35 U.S.C. §112, paragraph 6, unless used as “means for—functioning—” or “step for—functioning—” in the Claims section.

Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the inventions may be practiced by placing the invention on a computer-readable medium and/or in a data storage (“data store”) either locally or on a remote computing platform, such as an application service provider, for example. Computer-readable mediums include passive data storage, such as random access memory (RAM) as well as semi-permanent data storage such as a compact disk read only memory (CD-ROM). In addition, the invention may be embodied in the RAM of a computer into a new specific computing machine.

Data elements are organizations of data. One data element could be a simple electric signal placed on a data cable. One common and more sophisticated data element is called a packet. Other data elements could include packets with additional headers/footer/flags. Data signals comprise data, and are carried across transmission mediums and store and transport various data structures, and, thus, may be used to transport the invention. It should be noted in the discussions within this disclosure that acts with like names are performed in like manners, unless otherwise stated.

Of course, the foregoing discussions and definitions are provided for clarification purposes and are not limiting. Words and phrases are to be given their ordinary plain meaning unless indicated otherwise. Further, although the following discussion is directed at information retrieval, it is appreciated that the teachings of the exemplary embodiment are equally applicable to database and other data collections in general.

The usage of any terms defined within this disclosure should always be contemplated to connote all possible meanings provided, in addition to their common usages, to the fullest extent possible, inclusively, rather than exclusively.

### Information Retrieval Systems and Methods

Certain terms used in connection with this section, at least in certain circumstances, are intended to have particular meanings. “Artifact” means any returned unit of information that is relevant to a given search that may or may not be returned as a result, such as a web page, a word document, a book, an image, a restaurant review, and the like. Any unitary search result is referred to as an “artifact.” “Result” or “Actual Result” means an artifact that has been returned as a valid response to a search. Alternatively, these terms may be used to identify the actual artifact once it has been referenced as a valid response. “Potential Result” or “Candidate” means an artifact that is possibly a result, but must be evaluated one or more times by an information search system to determine if it is a truly valid result. “APHI” means All Published Human Information. “UIPHI” means Unpublished, Inaccessible or Private Human Information. “Contype” is a portmanteau shorthand term for “type of content.” “Target” is an abstraction for the target space of a given search. In an ideal search all results lie within the target. “Meta-Target” is an abstraction for the space inhabited by all possible valid results for a given search. “HEST” means the Heuristic Encapsulation of Search Terms. HEST provides specific interactions that enable an application to prompt for, and/or extract from, user disambiguation cues and isolate specific terms for specific ontological axes or search grammar forms. “Search Grammar” means a set of structural rules that govern the composition of search terms for the purpose of disambiguated user intent within an information search system. “Search Grammar Forms” means a set of categorical concepts that make up search grammar, each of which corresponds to a specific or meta-search term category. “tele” means a meme encoded within the text of an artifact. “Vaeme” means a meme encoded within an audio/video, audio, or video medium.

Some of the context for the various embodiments described herein may be given by way of the specific example below.

### Cartesian Challenges and Single Dimensional Search Solutions

Consider a term, in the context of an information retrieval system: “Journalism.” What is meant by the user when the term “Journalism” is entered? What is the intent of the user? In the context of any general search system this search term is the source of an extremely large array of potentialities. While a single definition may be applied to such a term, this does little to guide a search system toward an understanding of the searcher's intent. Is the searcher seeking information about educational programs in journalism, the theory of journalism, the practice of journalism, professional organizations in journalism, the current state of journalism within some specific context, journalism sources, etc.? Typical solutions to this problem include: (a) ignoring it—to not concern ourselves with intent and address this term as a key term (i.e., apply broad relevance interpretation on a variety of content single detections that hit on the word “journalism” (and perhaps some of its semantic relatives}, (b) eliciting additional words that either provide a semantic context (e.g., keyword/phrase hinting), or (c) encouraging the addition of further keywords to the term set in order to seek out a more complex keyword result. In other words, traditionally, the only method available to make such a search more specific was to obtain more words from the searcher. In certain ways, this makes some degree of sense. There is not, de facto or otherwise, any form of grammar for search. There are many forms of grammar for logic, but these are not necessarily the same thing. So, traditionally, the only way we can know user intent with any greater specificity is if the user enters another term.

Now consider the search term: “China Journalism.” Again, we have a problem. Even with an additional term, we have a very broad and very imprecise potential result set. Yes, things have been narrowed, but it is the logic that has become narrower. Now we have two very broad categories, each of which could be referring to a specific semantic concept that is not observable based on the current input.

It is important to note, however, that these descriptions are not accurate in most common search tools. Google™, for example, takes the input of two terms and by default applies a Boolean “OR” rather than a Boolean “AND.” Why is this? Base line heuristic would argue that a default “AND” would make more sense. There must be some other answer as to why the “OR” is the default Boolean relation to broad solutions. To understand this answer you must understand the mathematical, and thus computational, effect of multiple terms.

Each term spawns a potential result set. The combined possible total result set is theoretically a Cartesian product (the product of two sets). So, if the potential result set of one term is A and the potential result set of the other is B, then the combined result set is A×B. The actual results may be smaller, because the Boolean “AND” requires that both terms be relevant in the returned set. However, each potential result must be examined (ahead of time or during results calculation) in order to determine if it is a potential result or an actual result. Therefore, though each additional term clarifies the logic, each term also creates additional required calculations. The challenge is that the required calculations grow much more rapidly than the logical precision they grant and much more rapidly than is appreciable by the user.

Now consider the following progression of seemingly narrower and narrower searches:

### China Journalism History

### China Journalism History Foreign

### China Journalism History Foreign Affairs

### China Journalism History Foreign Affairs American

### China Journalism History Foreign Affairs American Media

### China Journalism History Foreign Affairs American Media January

### China Journalism History Foreign Affairs American Media January 2010 Interview Author

Each addition term increases the computational resources needed without appreciably narrowing the field of inquiry until we there are so many terms that it is unwieldy from a usability perspective and from a computational perspective. There has been a lot of improvement here. Google™ supports as many as 32 terms. The question is, at what cost?

This is why systems like Google™ rely on loose Boolean rules and soft Boolean defaults. Any form of Boolean precision makes the required computational power increase at an unsustainable rate. The input terms only increase linearly, but the required computational power increases as a Cartesian product of each potential set for each term.

To overcome this limitation, a number of strategies are employed such as pre-calculation. However, the nature of these solutions emphasizes a keyword-oriented world view that inculcates a certain point of view, which makes not only the implementation, but the very conception, of alternate solutions difficult to conceive. In other words, these solutions have costs that go unnoticed and these costs can limit the growth of meaningful alternatives. This is not to say that keyword relevance is not highly important (all solutions rely on these well-known methodologies to at least some extent). Rather, our critique is that extant solutions rely on keyword-oriented perspectives to the extent that they are taken for granted rather as one tool in a possible tool set.

Perhaps one of the most important aspects of this problem is the quality of the search results. One might expect that a search like “China Journalism History Foreign Affairs American Media January 2010 Interview Author” would yield a set of highly-focused results if put into a search engine like Google™. In fact, however, the top results to that search yield:
Fareed Zakaria—Wikipedia. the free encyclopedia en.wikipedia.orglwiki!Fareed ZakariaCac!ied—After directing a research project on American foreign policy at Harvard, Zakaria, Zakaria is the author of From Wealth to Power: The Unusual Origins of America's World, to Zakaria as one of the 25 most influential liberals in the American media . . . In January 2010, Zakaria was given the “Padma Bhushan” award by the . . .
Thomas Friedman—Wikipedia, the free encyclopedia en.wikipedia.org/wiki!ThomasFriedmanCached—Thomas Loren Friedman (born Jul. 20, 1953) is an American journalist, . . .
Show more results from wikipedia.org
Media Censorship in China—Council on Foreign Relations www.cfr.org>ChinaChaced
Mar. 7, 2011—But as a flourishing Cl1ina expands its international influence, many of its citizens . . . Jan. 14, 2010 . . . C/1inese Technology Policy and American Innovation . . . Author Isabella Bennett, Research Associate . . . As of December 2010, China was tied with Iran for the most jailed journalists in a single country . . .
Staff 1 Foreign Affairs
www.foreignaffairs.com!about-us/stafiSimilar
He is the author of How Wars End (Simon & Schuster, 2010) . . . Jonathan Tepperman was appointed Managing Editor of Foreign Affairs in January 2011 . . .
David Shapinsky I LinkedIn
www.!inl<edin.comlinlshapinskySimiiar
Washington D.C. Metro Area—Senior Advisor. Office of External Affairs, FDA—FDA
I am a long-time journalist and media professional with experience in national news, . . . history, US-China-Japan relations, as well as American and international history . . . January 2005-November 2009 (4 years 11 months) . . . Online Writer/Reporter . . . stories, working undercover, and conducting multi-camera interviews . . .
China—The New Tork Times
Topics.nytimes.com>World>Countries and TerritoriesCahsed-Similar
4 hours ago—As relations between Taiwan and China have warmed, Kinmen has stood as a test case . . . China's Adoption Scandal Sends Chills Through Families in US . . . A writer chronicles his daring escape over the border to Vietnam . . . that a United Nations international convention has sought to outlaw since 2010 . . .
Bill Moyers Journal: Vietnam Archives
www.pbs.org!moyersljoumaflblog/vietnam!Cached-Similar
You can watch ““LBJ's Path to War” and the David Simon interview in their entirety . . . Below is an article by Public Affairs Television senior writer Michael Winship . . . the Chinese authorities while reporting on pro-Tibet demonstrations in Beijing . . . of BILL MOYERS JOURNAL, Bill Moyers spoke with American histotian Henry . . .
New America Media news.newamericamedia.org!Cas:;hed-Similar
New America Media is a nationwide association of over 700 ethnic media organizations representing the development of a more inclusive journalism . . . Our Writers & Editors . . . way toward greatness, the movie became the biggest box office hit in China's history . . . New America Media, Interview, Sandip Roy, May 13, 2010 . . .
American President John Fitzgerald Kennedy
mi!lercenter.orglpresidentlkennedyQached—Similar
Derek Catsam on the US, and South African boycotts and their roles in . . . Foreign Affairs editor Gideon Rose on the difficulty of transitioning from war to peace . . . Old Media, New Media and the Challenge to Democratic Governance. Foreign Policy A Way Ahead with China: Steering the Right Course with the Middle . . .
[PDF]
New Foreign Policy Actors in China, SIPRI Policy Paper no. 26 books.sipri.orglfiles/PP!SIPRIPP26.pdtSimilar
File Format: PDF/Adobe Acrobat—Quick View to policymakers, researchers, media and the interested public. The Governing Board . . . China seeking to influence Chinese foreign policy, their policy preferences and . . . 27 researchers; 4 journalists; 2 active bloggers and 8 foreigners with long China-. 1 . . . 2010; and Beijing-based US China scholar, lntefView with author, . . .

What is remarkable about these results is their lack of specificity. The two things most of these results seem to have in common are: (1) their inclusion of references to many of the terms included in the search—but not in a meaningful context with one another—so that the results are more a pastiche around the terms, rather than on the totality of the terms; and (2) no single result really seems to contain anything that matches the exact specificity of the topic. At best the results could be said to be near the topic.

It is our belief that the first problem is related to the limitations of the Boolean assumptions made by Google™ and an overly-heavy reliance on a keyword-oriented world view. We believe that the Google™ example is one of the most effective in the space at this time, but we assert that it is missing something fundamental that would enable it to obtain greater specificity. The most troubling trend about Google™ results in the last few years is that they seem to rely more and more on the user having to open and examine results. Users are expected to do qualitative and specificity examinations on the results manually in order to really find what they are looking for. And, because there is no better solution, this has quietly been adopted as the state-of-the-art. There are a number of reasons for the occurrence of this trend, some of which are technological and some of which are in the nature of the problem and scale of the information that broad information search systems like Google™ address.

### A Grammar of Search

It is our belief that a reversal of this trend would enable a new or existing search competitor to obtain substantial market advantage. A number of the concepts described herein address this precise issue. At the core of these ideas is the concept that a Grammar of Search must be created and employed. Such a grammar should accomplish a number of things including, without limitation:

1. Enabling users to more clearly communicate their search intent;

2. Enabling search user interfaces to more effectively disambiguate search intent and provide hinting that supports that enablement;

3. Enabling content publishers to more accurately describe how they intend their content to be understood in relation to a searcher's intent;

4. Providing standardized means for algorithmic indexing engines to assess and categorize content in relation to a searcher's intent; and

5. Empowering results with great specificity.

Goals such as these have been associated with the promise of semantic search solutions. While somewhat promising, those solutions have proven more difficult to implement than many had predicted and, when implemented, have delivered less robust effects than anticipated. Both this greater difficulty and the relative paucity of resulting performance enhancements are in large part due to the fact that even a fully semantic interpretation of natural language lacks both the logical and heuristic specificity necessary to deliver strongly disambiguated search terms and clear Boolean logic.

Again, we assert that the introduction of a search-specific grammar, implemented on both the search user and content publisher sides of the problem will greatly enhance the searcher's ability to create highly disambiguated and specific search terms with robust Boolean logic.

It is known that in elementary education, kids may be taught grammar-sentence diagramming. An interactive interface could provide a powerful vehicle to enable users to understand the ways in which their input terms are interpreted by the search interface. Providing this feedback in real-time as the user enters terms provides the user with valuable insight and understanding of how the system will react to their input.

This “search grammar diagramming” can take a number of embodiments, including various forms of modified Venn diagrams and similar diagrams that display Boolean relationships, various dynamic labels that illustrate how the various “forms of search” are interpreted, and HEST (see below) among others. The various parts of “search grammar” include the following:

1. Objective—the searcher's meta-intent (segment modeling) [user contype];

2. Publisher meta-intent (publisher's objective implied) [publisher contype];

3. Subject—“Signal” space I semantic coordinate I keyword relevancy [subject] [keyword relevancy AND OR semantic bridging];

4. Medium—an expression of the type of information the searcher is seeking. This identifies things such as “restaurant (real world),” “lodging,” etc. in one part of its ontology and medium/formats in another: “PDF file”, “web page” etc.;

5. Temporal [age];

6. Sector—public, private, corporate, individual, for profit, not for profit, etc. (sector) (publisher source type). This facet addresses the question of, “Whose opinion does this content represent?”;

7. Boolean linkages (between terms [AND, OR, etc.], defining term sets [SET, . . . ], and specific to terms [NOT, MUST, WEIGHT, etc.])

These components are assembled to form a search. Any of these parts of grammar can be structured as one or more of the following: an ontology (dynamic or fixed), keyword relevance domain, folksonomic domain, or fixed set (controlled vocabulary [http://en.wikipedia.org/wiki/Controlled_vocabulary]). In one example embodiment, Boolean linkages are a fixed set, Subject is a keyword relevance set, and the remaining components are fixed ontologies.

A given search based on these parts of search grammar could include as little as one component (e.g., “journalism”[subject]—equivalent to a current-state Google™ Internet search), or could be a compound set of multiple parts with no current equivalency {e.g., “shopping” [objective], “store” [medium], “new” [temporal], etc. While the terms in this search are not dissimilar from terms one might see in a current-state Google™ search, they have a much higher degree of specificity and are far more disambiguated because the system can identify the part of search grammar for each term. Even if the system is automatically determining the part of search grammar for each term—if, that interpretation is communicated effectively to the user, the search experience is enhanced and the searcher's ability to build highly-focused, unambiguated searches is likewise enhanced.

A grammar built this way, in one embodiment would have the following features:

1. The ability to display constant feedback regarding the Boolean relationships between terms in an easily understood, and easily changeable manner.

2. The ability for any component to be implicit or explicit. That is, depending upon usage, the system can interpret some components as undefined, specified, or implied.

3. The ability for specific terms to be altered so that they will be interpreted as one form of search grammar or another.

4. The ability to communicate to the user the possible/available parts of grammar to which any given term may be altered.

5. The ability for content owners to understand how their content is interpreted in these terms by the algorithmic aspects of the system.

6. The ability for content owners to manually override how their content is interpreted in these terms by the algorithmic aspects of the system

7. The ability for moderators or editors, traditionally employed, crowd-sourced, or otherwise engaged with the provider of the information search system to override the content owner's selections.

8. The ability for searchers to choose to subscribe to any or all of the sets of interpretation (algorithmic, owners, editors/moderators) as part of the search.

There are also specific challenges that would be faced by such a search grammar:

1. How to enlist the help of content publishers so that they voluntarily offer to define their own content within the framework of the search grammar. (e.g. crowd-sourcing publisher incentives).

2. How to account for the fact of human nature that content publishers may be reluctant to provide such work. (non-pay direct and indirect incentives}.

3. How to account for the fact that some content publishers may forever decline to provide such work. (algorithmic fallback).

4. Such a grammar based system may in fact (and it is our desire for it to be) more transparent both algorithmically and process-wise to the publisher and advertiser. Thus, another challenge is how to prevent content publishers from “gaming” the system (a current and perpetual problem for information search systems). (limited ontological affiliation).

5. To ensure that the search user understands easily and clearly the distinctions regarding the search grammar and the corresponding ontologies work; ideally these ideas are communicated in an intuitive and self-apparent way that relies neither on natural language interpretation or other artificially-intermediated methods.

It should be understood that the Cartesian challenges posed by single-dimensional linguistic search solutions can be scaled down by the usage of Search Grammar.

### UPHI and the Principle of Continuous Information Expansion

APHI and UIPHI are two terms that have been coined to describe the content that is specifically addressed and specifically excluded from broad information search systems. They are both acronyms.

APHI, or All Published Human Information, (ayf eye) is a term that refers to the complete universe of all accessible and searchable information. A full, broad information search system addresses the APHI. While no current system does so, we believe the eventual outcome of broad search solutions such as Google™ will result in this scale of search.

UUIPHI, or Unpublished, Inaccessible or Private Human Information (weef-eye) is a term that refers to all the privately-held, confidential, closed, inaccessible, or otherwise unavailable information that cannot be searched even by broad information search systems. Though specialized systems may provide access to some of this information, it will likely never (and could be argued, should never) be accessible in its entirety to broad information search systems. Over time, sections of UIPHI tend to migrate into APHI.

### Principle of Continuous Information Expansion

A realistic system that addresses the problems related to broad information search must take into account what we refer to as the Principle of Continuous Information Expansion. As long as the human species continues to exist, it will continue to create and disseminate new information. To the extent that any human being needs to be concerned about it, this is a perpetual state of the universe.

Perhaps one of the most significant aspects of this principle in the context of these example embodiments is that it presents an enormous challenge to all extant information search systems. Such systems, whether based on linguistic models such as keyword relevance (e.g., Google™) or single-dimensional categorization (DOC) or semi-rigid uniform multi-dimensional categorization (Facet/Colon), all such systems essentially organize any given target into a single domain. Whether the domain is dynamically or rigidly assigned (e.g., based on folksonomy or a fixed vocabulary), is irrelevant to the fact that that a domain grows over time. The rate of growth also shows a well proven trend to accelerate over time. This is true in every domain in every field of knowledge. The corresponding complication that these systems face is that finding some specific artifact that meets the desire/need of the searcher increases in scale every day. The system types identified above have no features that allow them to adequately cope with this problem aside from adding additional terms, and thereby increasing the cognitive load on the searcher and increasing the computational and data load on the system. We describe this concept as the “Principle of Progressive Search Debt.” According to this concept, over time, any information search system faces a persistent and increasing difficulty in maintaining relevance and specificity.

The systems according to at least some of the example embodiments do not eliminate this challenge, but they do provide a toolset that enables much more progressive management of the challenge. The tool set includes, without limitation, the following:

1. Search Grammar—this enables significant user cognitive load and computation load reductions.

2. HEST—this enables significant user cognitive load reductions.

3. Multi-Dimensional Relevance—this enables significant computation load reductions.

4. Multi-Dimensional Relevance Signal to Noise Disambiguation—this enables significant cognitive load reductions.

It should also be understood by anyone skilled in the art that a gain in heuristic efficiency (e.g., a significant reduction in cognitive load requirement) that does not diminish the quality of the results also has a cascade effect in reducing the computation load of any given system in that with users able to more efficiently express their need/desire to the system the user-system interactions tend to be much more efficient and focused.

### The Heuristic Encapsulation of Search Terms (HEST)

The Heuristic Encapsulation of Search Terms provides specific user interface interactions that enable an application to prompt for, and/or extract from a user disambiguation cues, and isolate specific terms for specific ontological axes [dynamic, fixed vocabulary, keyword, etc.]. The user interface in question encloses the text (e.g., term or potential term(s)) entered by a user within graphical elements that are not text. These graphical elements may take any of a number of different forms as desired. In one example, the graphical elements comprise rectangles with or without additional text labels. In another example, the graphical elements comprise circles. In another example, the graphical elements comprise various geometric shapes that surround or substantially surround or cover the text.

The graphical elements may also provide visual anchors that may indicate: (1) a specific interpretation of the term has occurred or been set; (2) that the user may modify the specific interpretation of the term(s); (3) the specific search grammar form that the term has been interpreted or set; (4) that this may be changeable by the user; (5) an offer of hints that display other available related terms or search grammar forms that are available or are suggested; (6} a display of the Boolean context of one or more terms in the context of one or more other terms or search grammar forms; (7) an offer of hints that display available or recommended options for other Boolean options; (8) a display of Boolean grouping of terms; and/or (9) an offer of hints that display available or recommended options for other grouping relationships.

When the user clicks on one of these visual cues, the term is modified corresponding to the clicked (or otherwise interacted-with (e.g., touch on a touch screen)) cue.

Example embodiments of these overlaid graphical elements are aimed at, among other things:

1. Streamlining the use of, understanding of, and interaction with Boolean logic in relation to the terms.

2. Streamlining the use of, understanding of, and interaction with Search Grammar in relation to the terms.

3. Stressing conceptual simplicity in a manner that enables increased specificity and disambiguation in the construction of simple and compound search terms.

It should be noted that these features could also de-emphasize streamlining and be employed in other embodiments to fully emphasize and communicate the potential complexity of the term set.

Existing, but different methods include:

1. Spell check highlighting in word processers and other language-oriented interfaces. (e.g., MS Word—the user mistypes “intention” and the user interface underlines the word in a colored wavy line. If the user right-clicks the word, a list of possible corrections appears. If the user clicks one of the corrections, the word is replaced.

2. Search term hinting as is provided currently by Bing™ and Google™. (e.g., a user types in “New York” and the user interface displays “New York City” and “New York Stock Exchange” and “NYSE” in a pick-list below the text entry field).

3. Similar to case 1—grammatical errors in MS Word.

As will be understood by those skilled in the art, HEST methodology provides a highly useful toolset for the expression of Search Grammar as described above, as well as for the disambiguation of Boolean relations among search terms.

### Meta Specificity and Multi-Dimensional Relevance

What has previously been described as a Search Grammar could also be described as a meta specificity model. In this case, each part of the grammar can be contemplated as a spatial dimension, with a specific target being aligned to a given term. Prior systems of content specification generally attempt to address the APHI as a single linear progression or a single ontology of classification. For example, the Dewey Decimal Classification system (DDC):
attempts to organize all knowledge into ten main classes. The ten main classes are each further subdivided into ten divisions, and each division into ten sections. This results in ten main classes, 100 divisions, and 1000 sections. DDC's advantage in using decimals for its categories allows it to be purely numerical, while the drawback is that the codes are much longer and more difficult to remember as compared to an alphanumeric system. Just as an alphanumeric system, it is infinitely hierarchical. It also uses some aspects of a faceted classification scheme, combining elements from different parts of the structure to construct a number representing the subject content (often combining two subject elements with linking numbers and geographical and temporal elements} and form of an item rather than drawing upon a list containing each class and its meaning.
Except for general works and fiction, works are classified principally by subject, with extensions for subject relationships, place, time or type of material, producing classification numbers of at least three digits but otherwise of indeterminate length with a decimal point before the fourth digit, where present (for example, 330 for economics+0.9 for geographic treatment+0.04 for Europe=330.94 European economy; 973 for United States+0.05 form division for periodicals=973.05 periodicals concerning the United States generally).
Books are placed on the shelf in increasing numerical order of the decimal number, for example, 050. 220, 330, 330.973, 331. When two books have the same classification number the second line of the call number (usually the first letter or letters of the author's last name, the title if there is no identifiable author) is placed in alphabetical order.

### Wikipedia

[http://en.wikipedia.org/wiki/Dewey_Decimal_Classification]

There are a number of cogent criticisms of the DDC, including:

1. It attempts to describe all of the APHI into a single linear dimension.

2. That single linear dimension can be duplicative (i.e., non-exclusive), though in some circumstances this can be thought of as an advantage, if acknowledged and leveraged correctly. (Simply put, for example, a book on “warfare in India” could be classified under “warfare” or “India”. Even a book on warfare in general could be classified under “warfare,” “history,” “social organization,” “Indian essays,” or many other headings, depending upon the viewpoint, needs, and prejudices of the classifier.—Wikipedia])

3. In order to serve as a valid mechanism for search, it requires users to know some specific knowledge search targets in order to find meaningful results.

4. We would also assert that, due to its infinitely hierarchical nature, the DDC is susceptible to the challenges posed by the Principle of Continuous Information Expansion in that over time, any particular locus in the system becomes less specific and thus less useful, and requires either or both increased mediation or the application of increased hierarchies to function effectively when implemented in the context of a search system.

In the face of constant memetic expansion (Continuous Information Expansion), an ideal information location system would enable users to know as minimal an amount of specific information about the subject as possible, while still permitting them to be very specific about the nature of what they are seeking—meta specificity.

A multi-dimensional relevance system (as disclosed) can utilize multiple dimensions of categorical (ontological, fixed vocabulary, folksonomic, unstructured tags, etc.) classification alongside any effective form of subject relevance (citation analysis, keyword relevance, etc.) to pinpoint precise locations in the APHI for a user who has little specific knowledge of what they are looking for. Among the advantages of such a system is the fact that it suffers less degradation of results quality over time due to continuous information expansion.

Systems like Google™ and Bing™ that rely so largely on keyword relevance and citation analysis suffer from a different set of problems than the DDC, although the symptoms are not dissimilar. Perhaps these symptoms are part of a broader set of phenomena that could be ascribed to information location systems that are experiencing scale fatigue, or (as asserted by S. R. Rangathan, too great a dependence on classification based on a linguistic level rather than any form of meta-classification). In the case of Google™-esque solutions, current signs of fatigue/linguistic reliance scaling problems:

1. Result sets are often occupied by intentional irrelevancies or referential but empty artifacts (various forms of spam, intentionally misleading by the content owner).

2. The system is caught in a double bind to support increasing specificity in that it:

Requires increasing keyword specificity (i.e., multiple keyword input) over time to find what the user really wants.

Result sets for any single search necessarily increase over time.

Increasing the number of separate terms has a practical upper limit in that it creates a Cartesian progression for computational support that rapidly becomes unmanageable—the computational requirements to search with specificity theoretically could reach a point where they exceed the available computational capability of the search system.

Increasing need for reliance on compound terms.

1. Difficulty (increasing or inherent) in distinguishing between significant information domains. That is, the system cannot reliably provide ontological handles to identify specific domains. For example, “government” could mean my government (geocontextually), theory of government, history of government, news about the government, oversight of some specific aspect of some form of undertaking or enterprise (governance), government operations, reference materials for my government, etc. This is in one respect a semantic problem, but extant semantic solutions that rely on natural language analysis are computationally unwieldy and far more difficult to implement than originally envisioned. They also have tremendous scaling challenges to contemplate across languages. (Note that fixed vocabulary I multi-dimensional/search grammatical systems have far fewer cross-language issues in some regards, and have other challenges in yet others).

In at least one example embodiment, a multi-dimensional relevance engine interacts with the user to determine what dimension each term is related to with or without reliance on natural language analysis to do so. The parts comprise:

1. Dimensions: (these are in the highest levels of dynamic ontologies).

2. Objective (what the searcher is looking for. At the highest abstract level this is always information, but the next layer is what really matters. These are issues of human need and desire: food, lodging, real estate, shopping, news, images, and employment) (this has a loose affiliation with the categories used in extant solutions—though the usage there is shallow and limiting rather than methodical and flexible).

3. Sector (government, private, individual, etc.)

4. Domain (sciences, arts, history, etc.).

5. Medium (book, blog, pdf, html, doc, video, etc.).

6. Subject (James Brown, Ayn Rand, Weimerauners, quadratic equations . . . keyword relevancies).

7. Temporality (age: date context relation, iterative (last update—may be separate)).

8. Format (fiction, reference, news, biography, white paper, blog, etc.).

9. Scale (size of the material—long or short format, book, article, entry, etc.).

Some embodiments use one or more of these dimensions. Other embodiments may use two or more of these dimensions.

It should be understood by those skilled in the art how multi-dimensional relevance and meta-specificity can reduce the potential result set for any given search and how they can be used to disambiguate the intent of publishers and searchers in each context of interaction.

### Multi-dimensional Relevance Channel Signal-to-Noise Disambiguation Hinting

In another example embodiments, the multiple dimensions may comprise, for example:

1. User meta-intent [user contype]

2. Publisher meta-intent [publisher contype]

3. “Signal” space/semantic coordinate/keyword relevancy [subject]

4. Medium [medium]

5. Temporal [age]

6. Sector: public, private, corporate, individual, for profit, not for profit, etc. (sector) (publisher source type). Whose opinion does this content represent?

The range of results within a channel will have a certain amount of results. If there are too many results the desired outcome will be hard to discern from the noise in the channel. The amount of noise in the channel can be used as a measure to trigger a request for additional refinement—to narrow the channel. Also, when noise or parts of the noise in any given channel (or the cross-comparison of two or more channels) cluster in any discernable way, this provides hinting directives that can be expressed in the user interface (i.e., communicated to the user) in order to enable the user to increase specificity or remove ambiguities. This also enables search types not possible with traditional algorithmic, tag, or folksonomy-based searches, such as, for example: {find) journalism [contypeJ (about) journalism [subject], or even (find) news [contype] (and/or) news [medium] (about) news [subject].

### Leles and Vaemes/Leletic and Vaemetic Heuristics (LVH)

### Leles and Vaeves/Lemes and Vaemes

These are terms based on the term and concept “memes.” [http://en.wikipedia.org/wiki/Memes]. Both can be thought of variously as:
1. Memes that are fixed and encoded in an artifact. Artifacts can be physical documents, digital documents, images, audio, video or other multimedia files—anything in the APHI.
2. Specific mediums for memetic transmission.
3. Encoded states of memes.
4. Leles and Vaemes differ from memes in that once encoded they are not mutable in intent only in interpretation.

Other terms include:

Lemes/Leles: letter encoded memes.

Vaeves/Vaemes: visual, video or audio encoded memes.

Psuedo-encoded: refers to memes that can be interpreted to be contained within a given artifact, whether logarithmically deducted or based on the subjective observation of a human.

Enmemes: general category including all of the above.

Not unlike memes, leles and vaemes are limited as a scientific concept in that they lack a precise quantitative definition—though they are highly useful in that they provide a convenient term for a piece of thought transferred from person to person—in this case encoded in an artifact. Applied methods are thus confined to the subjective algorithm or process that is used to identify their existence within a population of artifacts. But, this quantitative “fuzziness” is not dissimilar to the mutability of precise word meaning within the context of a given semantic network, and thus can also be viewed as a strength rather than a weakness for deriving and identifying meaning from a population of artifacts. These terms can be used as convenient means to discuss the unitary nature of various linguistic concepts as they are embodied within artifacts.

### II. Database Search Enhancements

Other example embodiments are concerned with database search enhancements. These examples relate to many Web-based and computer-based applications, including, but not limited to search, social network applications and information retrieval processes that support these applications.

Certain definitions apply to this section as follows:

“Information Retrieval” (IR) is a field, the purpose of which is the assembly of evidence about information and the provision of tools to access, understand, interact with, and/or use that evidence. It is concerned with the capture, structure, analysis, organization, and storage of information. It can be used to locate artifacts in order to access the information contained therein or to discover abstract or ad-hoc information independent of artifacts.

An “IR System” is one or more software modules, stored on a computer readable medium, along with data assets stored on a computer readable medium that, in concert, perform the tasks necessary to perform information retrieval.

“Information” denotes any sequence of symbols that can be interpreted as a message.

“Artifact” can have the meaning provided above. Alternatively, “artifact” denotes any discrete container of information. Examples include a text document or file (e.g., a TXT file, ASCII file, or HTML file), a rich media document or file (e.g., audio, video or image such as a PNG file), a text-rich media hybrid (e.g., Adobe PDF, Microsoft Word document, or styled HTML page), a presentation of one or more database records (e.g. a SQL query response, or such a response in a Web or other presentation such as a PHP page), a specific database record or column, or any such machine-accessible object that contains information. The above list includes artifacts that are accessible by information technology. By extrapolation, artifacts can include reference to or meta-information about, regarding or describing physical objects, people, places, concepts, ideas or memes. Additional examples, in various embodiments, could also include references to domains or subdomains, defined collections of other artifacts, or references to real-world objects or places. While information technology systems provide reference to or presentations of these references, descriptions of the use process often conflate the reference artifact and the actual artifact. Such conflations should be interpreted referentially; in context to a process or apparatus as a reference; in context to a human being as the actual artifact, except whereas denoted as a representation of a term characteristic, facet presentation or other user interface abstraction.

“Ad Hoc Information” denotes types of information that is represented, or can be demonstrated to be true, independently of a specific single source artifact. This comprises information about information (e.g., the query entered returned n number of results) that is a result for a query for information and may not reside in any discrete artifact prior to interaction with an IR system. (Though, of course such information could have been created by identical prior queries and cached in an artifact.) This can also describe information that is derived from other information, or from a large set of distinct artifacts and can be said to be generally true based on that evidence; an observable fact that can be derived from observing one or more artifacts that may or may not be explicitly contained within the target artifact(s).

“Abstract Information” denotes information that is represented, or can be demonstrated, to be true, independently of a specific single source artifact. This includes mathematical assertions (e.g., 5=10/2) or any statement that can be asserted as corresponding to reality, independent of a source artifact. In an IR context, such information is almost exclusively a construct of user perception and intent. In operation of a given IR apparatus, queries for such information almost exclusively rely on a source artifact. While this may seem to be a pointless semantic distinction, it is important for interpreting many expressions regarding user intent.

“Structure” denotes that IR must include processes that address information that exists in a variety of forms; structured, unstructured or heterogeneous (e.g., a database record with “fields” or a text document with “text content” or a multimedia document with both).

“Analysis” denotes that IR must necessarily include processes that analyze the component characteristics of information. These include, but are not limited to, context (including, without limitation, location, internal citations and external citations), meta-characteristics (including, without limitation, publish date, author, source, format, and version), terminology (including, without limitation, term inclusion, term counts, and term vectors), format (e.g., physical and/or objective), empirical classification, or knowledge discovery (i.e., machine learning or artificial intelligence analysis that leads to categorizing a given artifact as belonging to one or more classes, typically part of a systematic ontology, and processes usually represented by one or more of Clustering, SVM, Bayesian Inference, or similar).

“Organization” denotes that IR must address the manner in which information is organized, both in the source artifact and in the storage of a resulting index. This is necessary to address the physical necessities of observing the contents of artifacts, the physical necessities of storing information about those artifacts, as well as the underlying philosophies that guide both.

“Storage” denotes that all artifacts that contain information and all indexes that contain information about artifacts must be physically stored in a medium. That medium will have rules, capabilities and limitations that must be part of the consideration of all IR processes. This includes, without limitation, databases (e.g., SQL), hypertext documents (e.g., HTML), text files (e.g., PDF; .DOCX), rich media (e.g., .PNG; .MP4). Storage also denotes that the IR process itself must store information about the artifacts it addresses (e.g., an index or cache).

“Evidence” denotes information about information that is used as an input or feedback within the IR system. Evidence may be used transparently, represented to the user within the user interface, or invisibly hidden from perception by the user. A query can be said to be comprised of components defining the evidence requirements for a desired result. Evidence is also a collection of characteristics that describe a result. Results that have the highest correspondence to a query's information need are the most relevant. The most relevant results are, ideally, the most useful in meeting the user's intent in searching for information, but this is not always the case. Usually, this is because of an imperfect correlation with the expression of a query with a user's actual intent. For most IR systems, even the best-formed query is at best an imperfect simplification of the actual user intent. This can occur for a number of reasons, including lack of understanding the manner in which the IR system operates, semantic error, too much ambiguity, too little ambiguity, and others. If all other aspects are equal, IR systems that achieve a higher degree of correlation between user intent and query input will produce better results, greater user satisfaction and competitive advantage. In certain contexts, “evidence” may be synonymous with the terms “signals,” “data,” or even “information.” Correlation between the evidence described in a query and evidence recorded in relation to a given artifact are the primary determinant of relevance (or ‘base relevance’). In many contexts and embodiments, “evidence” can also include a representation of the artifact that is the subject of the total evidence set. This representation may be a literal copy, stored in a given location, or may be tokenized, compressed, or otherwise altered for storage and/or efficiency purposes.

“Tools” denotes the interactive apparatus of the system, primarily the user interface (UI), but also includes the underlying components, processes and interconnected systems that enable the user to interact with the IR system and the concepts and ideas that drive it as well as the component facets, categories or other characteristics that impart structure and organization to the manner in which evidence, results and artifacts are accepted, assembled and presented by the IR system.

The ultimate purpose of IR is usability by and accessibility for human beings even if that usability is several steps removed from presentation to a human user. Evidence generated (e.g., retrieved, observed, collected, predicted, Lagged or classed) by IR systems is composed of fallible interpretations of the source artifact and fallible organization of evidence in the form of ontologies or other categorical structures. It would be a false assertion to claim that any representation of a source artifact stored by an IR process is not in some manner distorted, even if that distortion is one of context alone. These distortions are a necessary part of an IR process. Many of the resulting qualities of distortion are positive (e.g., processing efficiency), but others may not be desirable (e.g., distortion of relevancy). An IR system that fails to address usability by and accessibility for human beings will only partially meet its potential value as a tool. If the utility of an IR system is not consumable by a human being it is irrelevant. By extension, the more consumable utility provided, the more valuable the system. Every IR system, through its structure, organization and user experience imparts and projects a particular world view and philosophy about the nature of information it addresses. This is a necessary part of an IR process, as information without organization and context is merely unusable data. Maintaining transparency to and even configurability of this world view increases the flexibility, usability, scalability and value of an IR system.

### Information Need

Information Need is the underlying impetus that drives a user to interact with an IR system. The primary interaction with an IR system is the query. Queries are most often some form of structured or unstructured string (text) input. Even in cases where queries are driven by complex rich media constructs (such as speech to text, chromatic or other processes) terms are almost always reduced or translated into string inputs. A truism of “search engine—user interaction” is that queries are usually a poor representation of what the user wants, and of the information need that drives it.

A number of techniques and processes have been developed to assist users to assemble, refine or correct queries so that they better express what the user wants. These include “query suggestion,” “query expansion,” “term disambiguation hinting,” “term meaning expansion,” “polysemic disambiguation,” “homonymic disambiguation,” and “relevance feedback.”

It is a common misconception among users that IR systems (e.g., search engines) are objectively truthful. The user typically believes the search engine is a means by which they can find accurate information. But, there is an increasing trend to view search engines with greater suspicion—a growing awareness that search engines distort results. Examples of such distortions occur in the IR marketplace, and these distortions can be both intentional and unintentional. In this environment, providing transparency to the process and organization of search are generally desirable in IR systems.

### Information Conveyance

Retrieval of information by the IR system (capture) is a distinctly different process from retrieval of information by the user (access). While these processes are closely related in the context of IR, they rely on two completely unrelated primary operators—a computer (or similar machine, or collection of similar machines) and a human being, respectively. IR is ultimately about facilitating access to information by the human being. One way to express this is that an IR system is an apparatus that conveys information from a collection of sources to a human being. There are at least four types of information conveyance that can occur in the usage of an IR system. These are:

1. Directed access to an artifact;

2. Education about an artifact;

3. Education about the perceived meaning of evidence input (terms, etc.); and

4. Information or inference about the organization of evidence in the IR system.

“Directed access to an artifact” means providing a hyperlink, directions, physical address or other means of access to or representation of an artifact. “Education about an artifact” means, through the user interface of the IR system, providing the user with information about an artifact that appears in search results (e.g., where the artifact is located, the title of the artifact, the author of the artifact, the date the artifact was created, the context of the artifact, an abstract or description of the artifact, or other similar information). This can also denote information about how the artifact is interpreted by the IR system, including but not limited to evidence and specific characteristics of evidence regarding the artifact (e.g., the most relevant terms or tags for the document outside the context of the current query, or those within the context of the query). This may include various forms of ad-hoc or abstract information. “Education about the perceived meaning of evidence input” means, through the user interface of the IR system, providing the user with information about terms or concepts that were either entered by the user, or may be relevant to the terms entered by the user. This may include a list of related terms, an encyclopedia-like text description of the meaning of the a given concept associated with the input, images or other multimedia content, or a list of possible interpretations of terms aimed at achieving disambiguation for polysemic terms. This may include various forms of ad-hoc or abstract information. “Information or inference about the organization of evidence in the IR system” means providing the user with information or inferences about how information may best be located using the IR system, with the tools that it provides or enables. A simple and common example of this kind of education occurs when, on most major search engines if a user enters the term “fortune 500 logos” a result similar to “images for fortune 500 logos,” which is a link to a vertical categorical search for the same terms. This prompts the user to interact with the system in a different manner and implies a more efficient use of the system in the future. Enabling these kinds of inferences on the part of the user enables them to make more insightful and efficient searches in the future. IR systems that actively promote these inferences and the work to expose the user to the characteristics of the IR systems world view, organization and philosophy can achieve higher quality interactions and results than those that do not. This may include various forms of ad-hoc or abstract information.

Ideally, the user interface of an IR system presents the information of each of these forms of conveyance in a manner that informs, educates, and motivates the user with respect to the system to enable increased performance in current and future use. A system that achieves aspects of this ideal should obtain competitive advantage against systems that do not.

### Specificity

In most extant IR systems, quality is typically measured solely on the response of the IR system to queries. However, superior user experiences and qualitative outcomes are achievable in systems that also apply measures of quality to input—input being the totality of terms and term qualifiers entered by the user and/or inferred by the system. For purposes of this disclosure the term “Specificity” is used to describe the general quality of inputs by the user, which may or may not include refinements, inferences, and disambiguations provided by the IR system. Input terms or queries with greater specificity can be said to be of higher quality than those of lower specificity. It is thus desirable for IR systems to produce, foster, inculcate, encourage, and/or produce through user interaction, user experience methodologies, or inference methodologies queries of greater specificity.

However, like relevance, specificity is best measured directly against the information need of the user. Such measures cannot always be directly and objectively derived by observation, though they can be inferred. In this sense it can be said that the greater the correlation between the user's information need and the systems interpretation of query and terms the higher the specificity of the query or terms.

The terms “term” and/or “input terms” are typically defined in relation to IR systems as the information (usually, but not always, written—also including, but not limited to, spoken, recorded or artificially-generated speech, braille terminals, refreshable braille displays, or other sensory input and output devices capable of supporting the communication of information) that is provided to the system by the user that comprises the query. For the purposes of this disclosure, these terms should be understood to be expanded beyond their customary meaning to also include a variety of additional meta-data that accompanies and complements the user input information. This additional information provides additional specificity to the query in that it can include (though is not limited to) dimensional data, facet casting data, disambiguation data, contextual data, contextual inference data, and other inference data. This additional information may have been directly or manually entered by the user, may have been invisible to the user, or may have been implicitly or tacitly acknowledged by the user. Data about how the user has interacted with the terms to arrive at the complete set of meta-data can also be included in some embodiments.

For the purposes of this disclosure the term “dimension,” “search dimension,” or “facet” in relation to a term or artifact evidence connotes a categorical isolation of the term or artifact in its use and interpretation by the IR system to a particular category or ontological class or subclass. Dimensionality can be applied to any number of kinds of categorical schemas, both fixed or dynamic, and permanent or ad-hoc. Both fixed ontologies (taxonomies) and variable ontologies can be applied as dimensions and can be implemented at various levels of class-subclass depth and complexity. In some embodiments and processes, dimensionality may refer to an exclusive categorization of an artifact, term or characteristic. In other embodiments, categorizations are not exclusive and may be weighted, include a number of dimensional references, and/or include a number of dimensional references with variable relative weights. For example, in one embodiment, a simple ontology may divide all artifacts into two classes: “fiction” and “non-fiction.” In this embodiment, if an artifact belongs to the “fiction” class it cannot belong to the “non-fiction” class. In another embodiment all artifacts may be sorted into two classes “true” and “untrue” with each artifact being assigned a relative weight on a specific generalized scale (e.g., 0 to 100, with 100 being the highest and 0 being the lowest) for each class. Thus, a given artifact might have a 20 “true” weight and an 80 “untrue” weight. Generalized scales may be zero-sum, or non-zero sum for these purposes. In still other embodiments, multiple ontologies or schemas could be combined. For example the “fiction/non-fiction” and “true/untrue” ontologies could be combined into a single IR system that exposes and enables searching for all four dimensions.

For the purposes of this disclosure, the term “dimensional data” in relation to a term or query should be defined as an association between a term and a collection of information that defines a dimensional interpretation of that term. In some embodiments, this may include references to logical distinctions, association qualifiers, or other variations and combinations of such. For example, the term “London” could be said to be associated with the dimension “place.” Further, the term “London” could also be said to be 90% associated with the dimension “place” and 10% associated with the dimension “individual:surname.” Further, through inference or manual user interaction, these weightings could be altered, or even removed. Further, through inference or manual user interaction, an association could be modified to a Boolean “NOT.” Further, through inference or manual user interaction, one or more terms could be associated as a set as collectively “AND” or collectively “OR.” One adequately skilled in the art can, of course, anticipate and apply numerous further logical iterations and variations on this theme.

For the purposes of this disclosure the term “facet casting” or “dimension(al) casting” in relation to a term or result indicates that a particular term has been either manually or automatically defined as targeting a specific search dimension. In some cases, this may be synonymous with dimensional data in that it describes term meta-data related to dimensional definitions. Unlike dimensional data, in some embodiments, facet casting includes no connotation of weighting or exclusivity. For example, in one embodiment, the term “Washington” could be cast in the dimension of “place” indicating that it is focused on geography or map information. Alternatively, “Washington” could be cast in the dimension of “person” indicating that it is focused on biographical or similar information. Whereas dimensionality is an evolution of prior extant ideas (though not contained in those ideas) in the field regarding faceting, the term “dimensional casting” may be preferred, as “facet casting” may be, in some contexts, confused as to be limiting to the bounds of the traditional meaning of “facet.” In this disclosure, any usage of the term “facet casting” or “facet” should be interpreted to include the broader meanings of “dimension” and “dimensional casting.”

For the purposes of this disclosure, the term “disambiguation data” in relation to a term, query, or result set connotes information that is intended to exclude overly-broad interpretations of specific terms. For example, a common ambiguity encountered by IR systems is polysemy or homonymy. In one embodiment, disambiguation data indicates one specific meaning or entity that is targeted by a term. For example, it may indicate that the term “milk” means the noun describing a fluid or beverage rather than the verb meaning “to extract.” In other embodiments, this data may comprise information that defines one or more specific levels, contexts, classes, or subclasses in an ontology or variable ontology. For example, the term “milk” may be specified to mean the “beverage” subclass of a variable ontology, while simultaneously being indicated to mean the “fluid” subclass of the same variable ontology, while being indicated to mean the class “noun” (the parent class of fluid and beverage), while being excluded from the class “verb.” Similarly, this data may span multiple ontologies, category schemas, or variable ontologies. For example, in the previous example, the term “milk” could also be indicated to belong to the class “product” in a second unrelated ontology as well as being categorized as “direct user entry” in a third categorization schema.

For the purposes of this disclosure, the term “polysemy” connotes terms that have the capacity for multiple meanings or that have a large number of possible semantic interpretations. For example, the word “book” can be interpreted as a verb meaning to make an action (e.g., to “book” a hotel room) or as a noun meaning a bound collection of pages, or as a noun meaning a text collected and distributed in any form. Polysemy is distinct, though related to, homonymy.

For the purposes of this disclosure, the term “homonymy” connotes words that have the same construction and pronunciation but multiple meanings. For example the term “left” can mean “departed,” the past tense of leave, or the direction opposite “right.”

For the purposes of this disclosure the term “stop word” connotes words that occur so frequently in language that they are usually not very useful. For example, in many IR systems the word “the” as a search term is largely not useful for generating any meaningful results.

For the purposes of this disclosure, the term “contextual data” in relation to a term or query connotes meta-data that describes the context in which the query was entered into the system. In some embodiments, this may comprise, but is not limited to: demographic or account information about the user; information about how the user entered the user interface of the system; information about other searches the user has conducted; information about other previous user interactions with the system; the time of day; the current geolocation of the user; the “home” geolocation of the user; information about groups, networks or other contextual constructs to which the user belongs; and previous disambiguation interactions of the user. In most embodiments, this will be information that is stored chronologically separately from the interactions in which the query was formed.

For the purposes of this disclosure, the term “contextual inference data” in relation to a term or query connotes meta-data that describes the context in which the query was entered into the system. In some embodiments, this can include all of the information described for contextual data, but also includes: information disambiguating the meaning of terms derived from semantic analysis or word context among the terms, and plurality or subset of terms. In general, contextual inference data differs from contextual data in that it is usually inferred from observation of the “current” or recent user interactions with the system.

### Dimensional Articulation

Higher degrees of specificity can be accomplished in IR systems by increasing the degree of “dimensional articulation” or simply “articulation,” which, for the purposes of this disclosure, connotes the degree to which terms have been contextually packaged with information that describes their relationship to, inclusion from, or inclusion within search facets or search dimensions. This can be said to describe the data stored about terms within the system, whether or not it is exposed to the user, and it can also be used to describe the degree to which this information is exposed to the user via the user interface. Additionally, this can be used to describe the degree to which artifacts collected within the system have been associated with one or more dimensions. The association of an artifact with a dimension, can, within the context of some IR systems, be referred to as “tagging.” For example, a given IR system could be described as being highly dimensionally articulated in its analysis of terms for producing query results, but having low dimensional articulation in its user interface. In either case, in many embodiments, the functional realization of that depth of articulation may be dependent upon the degree to which the artifacts are dimensionally articulated (tagged or associated with one or more dimensions).

For the purposes of this disclosure the term “fixed articulation” or “fixed” in reference to a term's dimensional articulation, especially, though not exclusively, to its exposure in the user interface of the IR system, connotes dimensional articulation that is characterized, in various embodiments, by at least one of the following or similar: applied to only one dimension; applied to only a single class or subclass of a dimensional ontology (fixed or variable); provides a very limited number of value options; includes or uses terms that can only be applied to one or few dimensions; does not permit the transference of a term from one dimension to another; in any other way does not conform to the connotations of flexible articulation; and/or in some embodiments do not (or do not clearly) expose to the user the manner in which the term's dimensionality is articulated.

For the purposes of this disclosure, the terms “variable articulation” or “flexible articulation” in reference to a term connote an IR system and/or IR system user interface that includes one or more of the following: facet term linking; dimensional mutability; facet weighting; dimensional intersection; dimensional exclusion; contextual facet casting; facet inference; facet hinting; facet exposure; manual facet interaction; facet polyschema; and/or facet Boolean logic. An IR system that exhibits several or all of these characteristics can be said to have high-dimensional articulation and to have a high degree of specificity.

For the purposes of this disclosure, the term “facet term linking” or “dimensional term linking” connotes a form of dimensional articulation in which search terms have one or more associations with a search dimension. This enables terms to express greater specificity within a search query and to provide more powerful information need correlation. This enables the IR system to provide improved information conveyance to the user and to improve specificity and information need correlation.

For the purposes of this disclosure, the term “dimensional mutability” connotes a form of dimensional articulation in which search terms may manually or automatically have their association with a search dimension changed to a different or a null association. This enables the quick translation, correction, disambiguation, or alteration of a term from one dimension to another. This enables the IR system to provide improved information conveyance to the user and to improve specificity and information need correlation.

For the purposes of this disclosure, the term “facet weighting” or “dimensional weighting” connotes a form of dimensional articulation in which a search term's dimensional association(s) may also be associated with a particular relative or absolute weight. Any number of generic or scaled weights may be used. This enables the IR system to improve specificity and information need correlation.

For the purposes of this disclosure, the term “dimensional intersection” connotes a form of dimensional articulation in which search terms with dimensional data may be combined as terms within a single query so that each included term is collectively associated with a Boolean “AND”; this could also be described as a conjunctive association or simply as conjunction. This enables terms to express an information need that spans two or more verticals or dimensions in a single search query and to improve specificity and information need correlation.

For the purposes of this disclosure, the term “dimensional exclusion” connotes a form of dimensional articulation in which search terms with dimensional associations may be associated with a Boolean “NOT”; this could also be described as a negative association or negation. Such terms act as negative influences for relevance returns. This enables terms to specifically express the exclusion of artifact evidence that corresponds to the term and to improve specificity and information need correlation.

For the purposes of this disclosure, the term “contextual facet casting” or “contextual dimensional casting” connotes a form of dimensional articulation in which the terms, and implicit or tacit dimensional association of terms, in the query or a subsection of the query may influence the manner in which the facet inference or facet hinting occurs. This enables the IR system to provide improved information conveyance to the user and to improve specificity and information need correlation.

For the purposes of this disclosure, the term “facet inference” or “dimensional inference” connotes a form of dimensional articulation in which search terms entered into a query are analyzed by the IR system and automatically cast, or hinted for casting, in the most likely inferred dimension(s). This enables the IR system to provide improved information conveyance to the user and to improve specificity and information need correlation.

For the purposes of this disclosure, the term “facet exposure” or “dimensional exposure” connotes a form of dimensional articulation in which search terms with dimensional association(s) have those associations exposed to the user. This enables the IR system to provide improved information conveyance to the user and to improve specificity and information need correlation.

For the purposes of this disclosure, the term “facet hinting” or “dimensional hinting” connotes a form of dimensional articulation in which suggested search dimension associations are displayed for each term in the query and which the user may interact with tacitly or implicitly to approve, accept, or modify the suggested casting. This enables the IR system to provide improved information conveyance to the user and to improve specificity and information need correlation.

For the purposes of this disclosure, the term “manual facet interaction” or “manual dimensional interaction” connotes a form of dimensional articulation in which the facet casting of search terms may be manually modified by the user of the IR system. This enables the IR system to improve specificity and information need correlation.

For the purposes of this disclosure, the term “facet polyschema” or “dimensional polyschema” connotes a form of dimensional articulation in which search terms may be cast across dimensions belonging to various organizational schemas within the same query. This enables the IR system to improve specificity and information need correlation.

For the purposes of this disclosure, the term “facet Boolean logic” or “dimensional Boolean logic” connotes a form of dimensional articulation in which the dimensional associations of search terms may also include associations with Boolean operators (e.g., conjunction (AND), disjunction (OR), or negation (NOT)). This enables the IR system to improve specificity and information need correlation.

For the purpose of this disclosure, the term “set” connotes a collection of defined and distinct objects that can be considered an object unto itself.

For the purpose of this disclosure, the term “union” connotes a relationship between sets, which is the set of all objects that are members of any subject sets. For example, the union of two sets, A{1,2,3} and B{2,3,4} is the set {1,2,3,4}. The union of A and B can be expressed as “A∪B”.

For the purpose of this disclosure, the term “intersection” connotes a relationship between sets, which is the set of all objects that are members of all subject sets. For example, the intersection of two sets, A{1,2,3} and B{2,3,4} is the set {2,3}. The intersection of A and B can be expressed as “A∩B”.

For the purpose of this disclosure, the term “set difference” connotes a relationship between sets, which is the set of all members of one set that are not members of another set. For example, the set difference from set A{1,2,3} of set B{2,3,4} is the set {1}. Inversely, the set difference from set B{2,3,4} of set A{1,2,3} is the set {4}. The set difference from A of B can be expressed as “A \B”. “Set difference” can be synonymous with the terms “complement” and “exclusion.”

For the purpose of this disclosure, the term “symmetric difference” connotes a relationship between sets, which is the set of all objects that are a member of exactly one of any subject sets. For example, the symmetric difference of two sets, A{1,2,3} and B{2,3,4}, is the set {1,4}. The symmetric difference of sets A and B can be expressed as “(A∪B)\(A ∩B).” “Symmetric difference” is synonymous with the term “mutual exclusion.”

For the purpose of this disclosure, the term “Cartesian product” connotes a relationship between sets, which is the set of all possible ordered pairs from the subject sets (or sequences of n length, where n is the number of subject sets), where each entry is a member of its relative set. For example, the Cartesian product of two sets, A{1,2} and B{3,4} is the set ({1,3}, {1,4}, {2,3}, {2,4}).

For the purpose of this disclosure, the term “power set” connotes a set whose members are all subsets of a subject set. For example, the power set of set A{1,2,3} is the set ({1}, {2}, {3}, {1,2}, {1,3}, {2,3}, {1,2,3}).

For the purpose of this disclosure, the terms “conjunctive” and “Boolean AND” connote the Boolean “AND” operator, connoting an operation on two logical input values which produces a true result value if and only if both logical input values are true. This is synonymous with the term “Boolean AND” and can be notated in a number of ways, including “aΛb,” “Kab”, “a && b” or “a and b.”

For the purpose of this disclosure, the terms “disjunctive” and “Boolean OR” connote the Boolean “OR” operator, connoting an operation on two logical input values which produces a false result value if and only if both logical input values are false. This is synonymous with the term “Boolean OR” and can be notated in a number of ways, including “aVb,” “Aab”, “a∥b” or “a or b.”

For the purpose of this disclosure, the terms “negative” and “Boolean NOT” connote the Boolean “NOT” operator, connoting an operation on a single logical input value which produces a result value of true when the input value is false and a result value of false when the input value is true. This is synonymous with the concept of “negation” or “logical complement” and can be notated in a number of ways, including “-a”, “Na”, “!a” or “not a”.

For the purposes of this disclosure, the term “categorical cast” or “literal cast” connotes a term that has been cast to represent an associated cast dimension, category, class, or segment. It is a specific form of term entry and resultant term interpretation wherein the term value and term denotata can be said to be identical. For example the text term “textbooks” is cast to represent the category “textbooks”; it literally denotes the category itself. The term and the denotata are identical. This differs from a term that has been cast as a particular dimension, but will be used as keyword within the category. For example, the term “dolphins” is cast in the dimension “aquatic mammals” or “NFL teams”; in this case the denotata of the casting differs from the term; “dolphins” are not synonymous with all things that are aquatic mammals or all things that are NFL teams. Rather, they are a subset or a single item within the superset of the casting. It should be note that a given segment, class or category, may, in some embodiments, be associated with more than a single label. The terms “eponymous” or “eponymous term” connote the same relationship between a term and its casting. Note that an eponymous casting need not require the term value and the category label to be identical signs; for example the term “buying” could be epnomyously cast as “shopping.”

For the purposes of this disclosure the term “denotata” connotes the place of meaning within the relationship between signs and the things to which they refer or mean. For example, the word “sheep” is a sign that consists of the five letters, of a set of four letters ({s,h,e,p}), arranged in a specific order (“s-h-e-e-p”); it is also the spoken word “sheep.” That sign refers to the concept, meaning, etc. (denotata) of the fuzzy, four legged mammal that populates pastures. Thus, the sign, term, or word sheep has the denotata of the animal to which the sign, term or word refers.

Search queries of greater specificity may be achieved by the utilization of various forms of organization of search dimensions. These are variously expressed in embodiments of the current invention as categories, schemas, ontologies, taxonomies, folksonomies, fixed vocabularies, and variable vocabularies.

For the purposes of this disclosure, the term “schema” connotes a system of organization and structure of objects, which are comprised of entities and their associated characteristics. A schema may be said to describe a database, as in a conceptual schema, and may be translated into an explicit mapping within the context of a database management system. A schema may also be said to describe a system of entities and their relationships to one another, such as a collection of tags used to describe content or a hierarchy of types of artifacts. A schema may also include structure or collections regarding metadata, or information about artifacts (e.g., schema.org or the Dublin Core Metadata Initiative).

For the purposes of this disclosure, the term “ontology” connotes a system of organization and structure for all artifacts that may be addressed by an IR system, including how such entities may be grouped, related in a hierarchy and subdivided or differentiated based on similarities or differences. Ontologies comprise, in part, categories or classes or types, which may be subdivided into sub-categories or sub-classes or sub-types, which may be further divided into further sub-categories or sub-classes or sub-types, etc. For example, one ontology could include the classes “trees” and “rocks”; the class “trees” could include the subclasses “deciduous” and “evergreen”; the sub-class “deciduous” could include the sub-classes “oaks” and “elms”; and so on. Given ontologies may be described as fixed, to rely on a fixed vocabulary and to have a known, finite number of classes. Given ontologies may also be described as variable, to rely on a variable vocabulary and to have an unknown, theoretically infinite number of classes. Ontologies are often hierarchical structures that can be used in concert with one another in order to provide a clear definition of a concept, object or subject. For example, the scientist Albert Einstein could be simultaneously defined in one ontology as “homo sapiens” while being defined in others as “physicist,” “German,” “former Princeton faculty,” and “male” in others. Similarly, the same subject, concept or object could be associated with multiple classes in the same ontology. For example, Leonardo da Vinci could be simultaneously associated within a single ontology with “sculptor,” “architect,” “painter,” “engineer,” “musician,” “botanist” and “inventor” (as well several others).

The term “taxonomy” is closely related to ontology. For the purposes of this disclosure the distinction between “taxonomy” and “ontology” is that within the context of a single “taxonomy” an object, subject, or concept can be classified only once, as opposed to “ontology,” where an object may be associated with multiple types, classes, or categories.

For the purpose of this disclosure, the term “vocabulary” connotes a collection of descriptive information labels that are associated with underlying categories, types or classes; the referent article to a given search dimension or search dimension value. Vocabularies are usually, but not always comprised of words or terms. For example “red,” “mineral,” and “dead-English poets” could all be examples of items in a vocabulary. Alternative vocabularies can include or be comprised of other objects or forms of data. For example, an embodiment of the current invention could utilize a vocabulary that included the entity “FF0000,” the hexadecimal value for pure red color in an HTML document.

For the purpose of this disclosure, the term “fixed vocabulary” connotes a vocabulary that that is generally established and remains unchanged over time. While some editing or updating of a fixed vocabulary may take place over the lifetime of an IR system, the concept of these vocabularies is that they remain constant over time. Fixed vocabularies are usually, but not always, also controlled vocabularies.

Inversely, the term “variable vocabulary” connotes a volatile or dynamic vocabulary—one that changes over time or grows dynamically as more items are added to it. Such vocabularies will likely vary substantially when sampled at one time or another during the life of an IR system. Variable vocabularies are usually, but not always, uncontrolled vocabularies.

For the purpose of this disclosure, the term “controlled vocabulary” connotes a vocabulary that is created and maintained by administrative users of an IR system, as opposed to the search users of the IR system.

For the purpose of this disclosure, the term “uncontrolled vocabulary” connotes a vocabulary that is created and maintained by the search users of the IR system, or the evidence that is acquired by the IR system about the artifacts it retrieves and analyzes.

For the purpose of this disclosure, the term “dictionary” connotes a vocabulary that couples labels with definitions (i.e., signs with denotata). Each label may be associated with one or more definitions, and it is possible that one or more labels may be associated with the same or indistinguishable definitions (e.g., polysemic or homonymic labels).

It should be noted that dictionaries and vocabularies are typically conceived in a manner that is without hierarchy. In other words, though the definition of the label (or sign) “anatomy” may have a relationship to the definition of “biology,” the organization of the structure of the vocabulary or dictionary does not recognize this hierarchical relationship.

For the purposes of this disclosure, the term “variable exclusivity” connotes an organizational system in which categories may either be mutually exclusive or inclusion permissive. Mutually exclusive categories are two or more categories with which a given artifact may be associated with only one, but not another. For example, an Internet page might be categorized as “child pornography” or “children's literature,” but it cannot be both. Inclusion permissive categories are two or more categories with which a given artifact may be associated with two or more. For example a given artifact might be categorized as “subject.medicine.pharmaceutical” and “segment.retail” without conflict. In at least some embodiments, the default state of all categories is allowed to be inclusion-permissive unless specifically configured otherwise. But, it is also possible to make the default state of a category mutually exclusive.

For the purposes of this disclosure, within the context of describing categorical structure, the term “flat” connotes un-hierarchical structures, generally having little or no “levels” or hierarchy of classification (i.e., a structure which contains no substructure or subdivisions).

For the purposes of this disclosure, within the context of describing categorical structure, the term “hierarchical” connotes structures that are modeled as a hierarchy—an arrangement of concepts, classes or types in which items may be arranged to be “above” or “below” one another, or “within” or “without” one another. In this context, one may speak of “parent” or “child” items, and/or of nested or branching relationships.

For the purposes of this disclosure, within the context of describing categorical structure, the terms “loose” or “unorganized” connote an organization, ontology, vocabulary, schema or taxonomy that has little or no hierarchy and is likely to contain multiple unassociated synonymous items.

For the purposes of this disclosure, within the context of describing categorical structure, the term “organized” connotes an organization, ontology, vocabulary, schema or taxonomy that has clearly defined hierarchy, tends not to contain synonymous items, and/or, to the extent that it does contain multiple synonymous items, those items are associated with one another, so that potential ambiguities of association are avoided.

For the purposes of this disclosure, the term “folksonomy” connotes a system of classification that is derived either from the practice and method of collaboratively creating and managing a collection of categorical labels, frequently referred to as “tags,” for the purposes of annotating and categorizing artifacts, and/or is derived from a set of categorical terms utilized by members of a specific defined group. Folksonomies are generally unstructured and flat, but variants can exist that are hierarchical and organized. Folksonomies tend to be comprised of variable vocabularies, though instances of fixed vocabularies being utilized with folksonomies also exist.

Examples of IR systems with low-dimensional articulation include the search portals Google™ or Bing™. When using one of these systems, the user by default is exposed to a general “Search” vertical category. The user may select one of several other verticals such as “News” or “Images.” While initially entering terms, the user may interact with the text entry box hints to disambiguate or, in some cases, make limited dimensional distinctions, but in general lacks control, exposure and/or interactions that enable the user to understand, modify, manipulate or fully express any dimensional information. After entering terms or selecting a vertical, the user, in some cases, may be provided with additional fixed articulation for some dimensions that are salient within the selected vertical. For example, within images, users are provided with additional dimensional or facet inputs on the left part of the screen that enable dimensional interactions with “time,” “size,” “color” etc. The articulation of these dimensional inputs is entirely fixed. While a large number of dimensions are exposed within the overall user interface of the search portal, only one categorical dimension (which in this case is synonymous with “vertical”) can be selected at a time.

FIG. 13 illustrates a Google™ UI. While a large number of dimensions are exposed within the overall UI of the search portal, only one categorical dimension (which in this case is synonymous with “vertical”) can be selected at a time.

Customarily, relevance is used solely as a measure of quality for results generated by an IR system. However, in context with systems that provide high degrees of dimensional articulation, relevance is also a measure of the quality of a number of system characteristics other than results generation, including facet casting, information conveyance and specificity. More relevant facet casting results in a higher correlation between a query and a user's information need. Apparatuses and processes that generate facet casting, facet inference, facet exposure and facet hinting may rely on relevancy processes and algorithms similar to those used to generate results (i.e., select and rank artifacts) in an IR system. Increased relevance that produces more intuitive, easy to understand, and contextually accurate responses within user interface features related to dimensional articulation increase the quality of information conveyance to the user, which has a cascading effect on the quality of queries (specificity) entered by the user, concurrently and in future interactions. These processes and effects form a feedback loop which raises awareness and understanding on the part of the user about how the IR system operates while also raising the quality of results generated by the IR system, including precision, user relevance, topical relevance, boundary relevance, single and multi-dimensional relevance, higher correlation between information need and results related to recency and higher correlation between information need and results in general.

### Result Quality Measures

Relevance is often thought of as the primary measure of IR system result quality. Relevance is in practice a frequently intuitive measure by which result artifacts are said to correspond to the query input by a user of the IR system. While there are a number of abstract mathematical measures of relevance that can be said to precisely evaluate relevance in a specific and narrow way;\, their utility is demonstrably limited when considered alongside the opaque (at time of use) and complex decision making, assumptions and inferences made by a user when assembling a query. A good working definition of “relevance” is a measure of the degree to which a given artifact contains the information the user is searching for. It should also be noted that in some embodiments relevance can also be used to describe aspects of inference or disambiguation cues provided to the user to better articulate the facet casting or term hinting provided to the user in response to direct inputs.

Two common measures of evaluating the quality of relevance are “precision” and “recall.” Precision is the proportion of retrieved documents that are relevant (P=Re/Rt where P is precision, Re is the total number of retrieved relevant artifacts and Rt is the total number of all retrieved artifacts). Recall is the proportion of relevant documents that are retrieved of all possible relevant documents (R=Re/Ra where R is recall, Re is the total number of retrieved relevant artifacts and Rt is the total number of all possible relevant artifacts). Precision and recall can be applied as quality measures across a number of relevance characteristics.

The degree to which a retrieved artifact matches the intent of the user is often called “user relevance.” User relevance models most often rely on surveying users on how well results correspond to expectations. Sometimes it is extrapolated based on click-through or other metrics of observed user behavior.

Another set of relevance measures can be built around “topical relevance.” This is the degree to which a result artifact contains concepts that are within the same topical categories of the query. While topical can sometimes correspond with user intent, a result can be highly topically relevant and not represent the intent of the user at all. Alternatively, if a multi-faceted IR system is employed, this could be expressed as the proportion of defined topical categories for which an artifact is relevant to the total number of topical categories that were defined.

Another set of relevance measures can be built around “boundary relevance.” This is the degree to which a result artifact is sourced from within a defined boundary set characteristic. Alternatively, this could be expressed as the number of discrete organizational boundaries that must be crossed (or “hops”) from within a defined boundary set characteristic to find a given artifact (e.g., degrees of separation measured in a social network). Alternatively, this could be expressed as the subset of multiple boundary sets met by a given artifact.

If an IR system utilizes faceted term queries (that is, evaluates relevance against isolated, stored meta-data about an artifact rather than the entire content of an artifact), then it can also utilize quality metrics that measure “single dimensional relevance,” that is, the degree to which result artifact corresponds to the query within the context of a given dimension. For example, if a search utilizes a geo-dimension and a user inputs a particular zip code, a given result can be measured by the absolute distance between its geo-location to that of the query. A collection of single dimensional relevance scores can be collected, weighted and aggregated to measure “multi-dimensional relevance.”

Other forms of quality measurement for IR systems focus on how rapidly new content can be added to the system, or, in cases where relevant, how quickly old content falls off or phases out of the system. “Coverage” measures how much of the extant accessible content that exists within the aggregate boundary set(s) of the system has been retrieved, analyzed, and made available for retrieval by the system. “Freshness” (or sometimes “Recency”) measures the “age” of the information available for retrieval in the system.

Another form of quality measurement is the degree to which spam has penetrated the system. “Spam” refers to artifacts that contain information that distorts the evidence produced by the IR system. This is often described as misleading, inappropriate or non-relevant content in results. This is typically intentional and done for commercial gain, but can also occur accidentally, and can occur in many forms and for many reasons. “Spam_Penetration” measures the proportion of spam artifacts to all returned artifacts.

Still other qualitative and subjective methods exist to measure the performance of an IR system. These include but are not limited to: efficiency, scalability, user experience, page visit duration, search refinement iterations, and others.

### Curation

“Curation” is a discriminatory activity that selects, preserves, maintains, collects, and stores artifacts. This activity can be embodied in a variety of systems, processes, methods and apparatuses. Stored artifacts may be grouped into ontologies or other categorical sets. Even if only implicitly, all IR systems use some form of curation. At the simplest level, this could be the discriminatory characteristic of an IR system that determines it will only retrieve HTML artifacts while all other forms of artifact are ignored. More complex forms of curation rely on machine intelligence processes to categorize or rank artifacts or sub-elements of artifacts against definitions, rules or measures of what determines if an artifact belongs to a particular category or class. This could, for example, determine what artifacts are considered “news” and what artifacts are not. In some embodiments, the process of curation is referred to as “tagging.”

In some embodiments curation depends on automated machine processes. Methods such as clustering, Bayesian Analysis and SVM are utilized as parts of systems that include these processes. For purposes of this disclosure, the term “machine curation” will be used to identify such processes.

In some embodiments, curation is performed by human beings, who may interact with an IR system to indicate whether a given artifact belongs to a particular category or class. For purposes of this disclosure, the term “human curation” will be used to identify such processes.

In some embodiments, curation may be performed in an intermingled or cooperative fashion by machine processes and human beings interacting with machine processes. For purposes of this disclosure, the term “hybrid curation” will be used to identify such processes.

“Sheer curation” is a term that describes curation that is integrated into an existing workflow of creating or managing artifacts or other assets. Sheer curation relies on the close integration of effortless, low effort, invisible, automated, workflow-blocking or transparent steps in the creation, sharing, publication, distribution or management of artifacts. The ideal of sheer curation is to identify, promote and utilize tools and best practices that enable, augment and enrich curatorial stewardship and preservation of curatorial information to enhance the use of, access to and sustainability of artifacts over long and short term periods.

“Channelization” or “channelized curation” refers to continuous curation of artifacts as they are published, thus rendering steady flows of content for various forms of consumption. Such flows of content are often referred to as “channels.”

### Human Machine Interaction

The term “Human-Machine Interaction” (or “human-computer interaction,” “HMI” or “HCI”) connotes the study, planning, and design of the interaction between people (users) and computers. It is often regarded as the intersection of computer science, behavioral sciences, design and several other fields of study. In complex systems, the human-machine interface is typically computerized. The term connotes that, unlike other tools with only limited uses (such as a hammer, useful for driving nails, but not much else), a computer has many affordances for use and this takes place in an open-ended dialog between the user and the computer.

The term “Affordance” connotes a quality of an object, or an environment, which allows an individual to perform an action. For example, a knob affords twisting, and perhaps pushing, while a cord affords pulling. The term is used in a variety of fields: perceptual psychology, cognitive psychology, environmental psychology, industrial design, human-computer interaction (HCI), interaction design, instructional design, and artificial intelligence.

The term “Information Design” is the practice of presenting information in a way that fosters efficient and effective understanding of it. The term has come to be used specifically for graphic design for displaying information effectively, rather than just attractively or for artistic expression.

The term “Communication” connotes information communicated between a human and a machine; specifically a human-machine interaction that occurs within the context if a user interface rendered and interacted with on a computing device. This term can also connote communication between modules or other machine components.

The term “User Interface” (UI) connotes the space where interaction between humans and machines occurs. The goal of this interaction is effective operation and control of the machine on the user's end, and feedback from the machine, which aids the operator in making operational decisions. A UI may include, but is not limited to, a display device for interaction with a user via a pointing device, mouse, touchscreen, keyboard, a detected physical hand and/or arm or eye gesture, or other input device. A UI may further be embodied as a set of display objects contained within a presentation space. These objects provide presentations of the state of the software and expose opportunities for interaction from the user.

The term “User Experience” (“UX” or “UE”) connotes a person's emotions, opinions and experience in relation to using a particular product, system or service. User experience highlights the experiential, affective, meaningful and valuable aspects of human-computer interaction and product ownership. Additionally, it includes a person's perceptions of the practical aspects such as utility, ease of use and efficiency of the system. User experience is subjective in nature because it is about individual perception and thought with respect to the system.

“Cognitive Load” connotes the capacity of a human being to perceive and act within the context of human-machine interaction. This is a term used in cognitive psychology to illustrate the load related to the executive control of working memory (WM). Theories contend that during complex learning activities the amount of information and interactions that must be processed simultaneously can either under-load, or overload the finite amount of working memory one possesses. All elements must be processed before meaningful learning can continue. In the field of HCI, cognitive load can be used to refer to the load related to the perception and understanding of a given user interface on a total, screen, or sub-screen context. A complex, difficult UI can be said to have a high cognitive load, while a simple, easy to understand UI can be said to have a low cognitive load.

The term “Form” (in some cases “web form” or “HTML form”) generally connotes a screen, embodied in HTML or other language or format that allows a user to enter data that is consumed by software. Typically forms resemble paper forms because they include elements such as text boxes, radio buttons or checkboxes.

### Code

“Code” in the context of encoding, or coding system, connotes a rule for converting a piece of information (e.g., a letter, word, phrase, or gesture) into another form or representation (one sign into another sign), not necessarily of the same type. Coding enables or augments communication in places where ordinary spoken or written language is difficult, impossible or undesirable. In other contexts, code connotes portions of software instruction.

“Encoding” connotes the process by which information from a source is converted into symbols to be communicated (i.e., the coded sign).

“Decoding” connotes the reverse process, converting these code symbols back into information understandable by a receiver (i.e., the information).

“Coding System” connotes a system of classification utilizing a specified set of sensory cues (such as, but not limited to color, sound, character glyph style, position or scale) in isolation or in concert with other information representations in order to communicate attributes or meta information about a given term object.

“Auxiliary Code Utilization” connotes the utilization of a coding system in a subordinate role to another, primary method of communicating a given attribute.

“Code Set” in the context of encoding or code systems, connotes the collection of signs into which information is encoded.

“Color Code” connotes a coding system for displaying or communicating information by using different colors.

### Other Information

For the purposes of this disclosure, the term “server” should be understood to refer to a service point which provides processing and/or database and/or communication facilities. By way of example, and not limitation, the term “server” can refer to a single, physical processor with associated communications and/or data storage and/or database facilities, or it can refer to a networked or clustered complex of processors and/or associated network and storage devices, as well as operating software and/or one or more database systems and/or applications software which support the services provided by the server.

For the purposes of this disclosure, the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, the term “database,” “DB,” or “data store” should be understood to refer to an organized collection of data on a computer readable medium. This includes, but is not limited to, the data, its supporting data structures, logical databases, physical databases, arrays of databases, relational databases, flat files, document-oriented database systems, content in the database or other sub-components of the database, but does not, unless otherwise specified, refer to any specific implementation of data structure, database management system (DBMS).

For the purposes of this disclosure, a “computer readable medium” stores computer data in machine readable format. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer. The term “storage” may also be used to indicate a computer readable medium. The term “stored,” in some contexts where there is a possible implication that a record, record set or other form of information existed prior to the storage event, should be interpreted to include the act of updating the existing record, dependent on the needs of a given embodiment. Distinctions on the variable meaning of storing “on,” “in,” “within,” “via,” or other prepositions are meaningless distinctions in the context of this term.

For the purposes of this disclosure, a “module” is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

For the purposes of this disclosure, a “social network” connotes a social networking service, platform or site that focuses on or includes features that focus on facilitating the building of social networks or social relations among people and/or entities (participants) who share some commonality, including but not limited to interests, background, activities, professional affiliation, virtual connections or affiliations or virtual connections or affiliations. In this context the term entity should be understood to indicate an organization, company, brand or other non-person entity that may have a representation on a social network. A social network consists of representations of each participant and a variety of services that are more or less intertwined with the social connections between and among participants. Many social networks are web-based and enable interaction among participants over the Internet, including but not limited to e-mail, instant messaging, threads, pinboards, sharing and message boards. Social networking sites allow users to share ideas, activities, events, and interests within their individual networks. Examples of social networks include Facebook™, MySpace™, Google+™, Yammer™, Yelp™, Badoo™, Orkut™, LinkedIn™, and deviantArt™. Social sharing networks may sometimes be excluded from the definition of a social network due to the fact that in some cases they do not provide all the customary features of a social network or rely on another social network to provide those features. For the purposes of this disclosure such social sharing networks are explicitly included in and should be considered synonymous with social networks. Social sharing applications including social news, social bookmarking, social/collaborative curation, social photo sharing, social media sharing, discovery engines with social network features, microblogging with social network features, mind-mapping engines with social network features and curation engines with social network features are all included in the term social network within this disclosure. Examples of these kinds of services include Reddit™, Twitter™, StumbleUpon™, Delicious™, Pearltrees™, and Flickr™.

In some contexts, the term “social network” may also be interpreted to mean one entity within the network and all entities connected by a specific number of degrees of separation. For example, entity A is “friends” with (i.e., has a one node or one degree association with) entities B, C and D. Entity D is “friends” with entity E. Entity E is “friends” with entity F. Entity G is friends with entity Z. “A's social network” without additional qualification, synonymous with “A's social network” to one degree of separation, should be understood to mean a set including A, B, C and D, where E, F, G and Z are the negative or exclusion set. “A's social network” to two degrees of separation should be understood to be a set including A, B, C, D and E, where F, G and Z are the negative or exclusion set. “A's social network” to various, variable or possible degrees of separation or the like should be understood to be a reference to all possible descriptions of “A's social network” to n degrees of separation, where n is any positive integer; in this case, depending on n, including up to A through F, but never G and Z, except in a negative or exclusion set.

The term “social network feed” connotes the totality of content (artifacts and meta-information) that appears within a given social network platform that is associated with a given entity. If associative reference is also given to artifacts via degrees of separation, that content is also included.

“Attributes” connotes specific data representations, (e.g., tuples <attribute name, value, rank>) associated with a specific term object.

“Name-Value Pair” connotes a specific type of attribute construction consisting of an ordered pair tuple (e.g., <attribute name, value>).

“Term Object” connotes collections of information used as part of an information retrieval system that include a term, and various attributes, which may include attributes that are part of a coding system related to this invention or may belong to other possible attribute sets that are unrelated to part of a coding system.

The term “sign” or “signifier” connotes information encoded in a form to have one or more distinct meanings, or denotata. In the context of this disclosure the term “sign” should be interpreted and contemplated both in terms of its meaning in linguistics and semiotics. In linguistics a sign is information (usually a word or symbol) that is associated with or encompasses one or more specific definitions. In semiotics a sign is information, or any sensory input expressed in any medium (a word, a symbol, a color, a sound, a picture, a smell, the state or style of information, etc.).

The term “denotata” connotes the underlying meaning of a sign, independent of any of the sensory aspects of the sign. Thus the word “chair” and a picture of a chair could both be said to be signs of the denotata of the concept of “chair,” which can be said to exist independently of the word or the picture.

The term “state” or “style” in the context of information connotes a particular method in which any form of encoding information may be altered for sensory observation beyond the specific glyphs of any letters, symbols or other sensory elements involved. The most readily familiar examples would be in the treatment of text. For example, the word “red” can be said to have a particular style in that it is shown in a given color, on a background of a given color, in a particular font, with a particular font weight (i.e., character thickness), without being italicized, underlined, or otherwise emphasized or distinguished and as such would comprise a particular sign with one or more particular denotata. Whereas the same word “red” could be presented with yellow letters (glyphs) on a black background, italicized and bolded, and thus potentially could be described as a distinct sign with alternate additional or possible multiple denotata.

The term “cognit” connotes a node in a cognium consisting of a series of attributes, such as label, definition, cognospect and other attributes as dynamically assigned during its existence in a cognium. The label may be one or more terms representing a concept. This also encompasses a super set of the semiotic pair sign/signifier—denotata as well as the concept of a sememe (cognits—pl.).

The term “cognium,” “manifold variable ontology,” or “MVO” connotes an organizational structure and informational storage schema that integrates many features of an ontology, vocabulary, dictionary, and a mapping system. In the preferred embodiment a cognium is hierarchically structured like an ontology, though alternate embodiments may be flat or non-hierarchically networked. This structure may also consist of several root categories that exist within or contain independent hierarchies. Each node or record of a cognium is variably exclusive. In some embodiments each node is associated with one or more labels and the meaning of the denotata of each category is also contained or referenced. A cognium is comprised of collection of cognits that is variably exclusive and manifold; can be categorical, hierarchical, referential and networked. It can loosely be thought of as a super set of an ontology, taxonomy, dictionary, vocabulary and n-dimensional coordinate system (cogniiums—pl.).

Within a cognium, the cognits inherit the following integrity restrictions:

5. Each cognit is identifiable by its attribute set, such as collectively the label, definition, cognospect, etc. The combination of attributes is required to be unique.

6. Each cognit must designate one and only one attribute as a unique identifier. This is considered a mandatory attribute and all other attributes are considered not mandatory.

7. Cognit attributes may exist one or more times provided the attribute and value pair is unique (e.g., the attribute “label” may exist once with the value “A” and again with the value “B”).

8. A cognit which does not have an attribute is not interpreted the same as a cognit which has an attribute with a null or empty value (e.g., Cognit “A” does not have the “weight” attribute and cognit “B” has a “weight” attribute that is null. Cognit “A” is said to not contain the attribute “weight” and cognit “B” is said to contain the attribute.).

9. The definition of a cognit must be unique within its cognospect.

10. Relationships and associations designated hierarchical between cognits cannot create an infinite referential loop at any lineage or branch within the hierarchy (e.g., cognit “A” has a parent “B” and therefore cognit “B” cannot have a parent “A”).

11. Relationships and associations not designated hierarchical between cognits can be infinitely referential (e.g., cognit “A” has a sibling “B′” and cognit “B” has a sibling “A′”).

12. Only one relationship or association defined in a mutually exclusive group may appear between the same cognits (e.g., cognit “A” is a synonym of cognit “B” and therefore cognit “B” cannot be an antonym of cognit “A”).

13. Any relationship and association between cognits must be unique (i.e., not repeated and not redundant) (e.g., cognit “A” is contained in cognit “B” may only exist once).

14. Relationships and associations defined in a mutually inclusive group will exist as a single relationship between cognits (e.g., if “brother,” “sister,” and “sibling” are defined mutually inclusive, only one is designated for use).

15. Relationships and associations defined as hierarchical automatically define a mutually inclusive group to parent ancestry and all descendants (e.g., Cognit “A” is a parent of cognit “B” and cognit “X” is a sibling of cognit “A.” Therefore, cognit “X” also inherits all associations to the parent lineage of cognit “A” and all children and descendants of cognit “A.”).

16. Relationships and associations defined in a rule set will be applied equally to all associated cognits (e.g., a rule which states that all cognits associated with cognit “A” require a label attribute will cause the cognium to reject the addition of the relationship to cognit “B” until and unless a label attribute is defined on cognit “B.”).

The term “cognology” connotes the act or science of constructing a cognium (cognological—adj, cognologies—pl.).

The term “cognospect” connotes the context of an individual cognit within a cognium. The context of a cognit may be identified by one or more attributes assigned to the cognit and when taken collectively with its label and definition, uniquely identify the cognit.

FIG. 14 illustrates an example of a categorical ontology that could be integrated with an example embodiment of the invention. Note that this drawing is a visual representation of the hierarchical associations of the ontology and is intended to communicate the structure of the elements of the ontology to a reader, but is not presented in machine readable form. It shows variously expanded branches under the “Form” class while all other classes are shown without expansion. This shows one example of classes and structures that could be used to convey meaningful categorization to the user of an embodiment of the system.

FIG. 15 illustrates a user interface of an example embodiment, with the intersection of three categories, one of which is an exclusion. Each term is shown as cast in a particular category class. This query is read to mean: select artifacts that are relevant to “Tom Brady” categorically as a person, “Boston” categorically as a place, but not relevant to “football” categorically as an activity. This query could alternatively be described as: select artifacts that are relevant to the category “person: Tom Brady,” and the category “place: Boston,” but not relevant to the category “activity:football.” This query could alternatively be described as: SELECT artifact WHERE category=“person: Tom Brady” AND category=“place: Boston” AND category!=“activity: football”. This query could alternatively be described as: SELECT artifact WHERE person=“Tom Brady” AND place=““Boston” AND activity!=“football”. It should be noted that this is distinct from a query that read: select artifacts that are relevant to the text “Tom Brady” and the text “Boston,” but not relevant to the text “football.” In the pictured embodiment, the two smaller circles pictured on the bottom right of the “ACTIVITY football” circle are term-related buttons. They indicate that the term they are adjacent-to is currently selected (or active) in the user interface). The term related button that is labeled with an “x” (X) when clicked or tapped removes the associated term from the query. The term-related button that is labeled with a dash or “minus sign”, “−” (−) when clicked or tapped toggles the NOT logical state of the term. The current state of the “ACTIVITY football” term is NOT, or Boolean FALSE. The current state of the other two terms is IS, or Boolean TRUE. It will be noted by one skilled in the art that there are a number of alternate embodiments that could be utilized to achieve a user interface that enables identical or similar functionality.

FIG. 16 illustrates a user interface of an example embodiment, with a query that shows the intersection of the term “sports” cast as the category “activity” and the term “philosophy” cast as the category “field” (as in field of study).

FIG. 17 illustrates a user interface of an example embodiment, wherein two intersected terms are nested within another single term. If one considers that the logical relationship between any two intersected terms may be toggled as an AND or OR state, then it becomes apparent how a nested visual expression such as this enables more complex logical arguments. For example, depending upon how the logical relationship between visually intersected terms is configured or expressed, FIG. could, in various embodiments represent any of the following: 1) Select artifacts where form=“quotation” and either keyword!=“sports” or keyword=“philosophy.” 2) Select artifacts where form=“quotation” and both keyword!=“sports” and keyword=“philosophy.” 3) Select quotations that either contain the word “philosophy” or that don't contain the word “sports.” 4) Select quotations that both contain the word “philosophy” and that don't contain the word “sports.” In each of these cases it can be seen how categorically cast concepts can be combined with more traditional keyword-oriented indexing. In some embodiments the nature of AND/OR in the expressions would be visually expressed. It is omitted here in order to demonstrate alternate embodiments.

FIG. 18 illustrates a user interface of an example embodiment, where a categorically cast term has been inferred by the system and a human being has interacted with the diagram interface in order to force a manual association with a different category. In this case the system selected “field” for the term “philosophy” and the user has interacted with the display of the selected/inferred category, opening a selection menu that displays all possible categorical expressions for the term “philosophy.” Note that the available categories here are shown as a flat, non-hierarchical collection, whereas they could just as easily be implemented to express a hierarchical relationship via various user interface techniques such as cascading menus. For example in the figure, “product” is shown as a root class, at the same level as “form” but in some embodiments “product” may be expressed as a child class of “form” and be depicted in the UI in an alternated method showing its position ‘under’ “form.”

FIG. 19 illustrates a user interface of an example embodiment, showing a query and a portion of associated return—a list of artifacts.

FIG. 20 illustrates an example of a categorical ontology that could be integrated with an example embodiment. Note that this drawing is a visual representation of the hierarchical associations of the ontology and is intended to communicate the structure of the elements of the ontology to a reader, but is not presented in machine readable form. It shows a single class, “Activity” which could comprise an entire ontology or only a subset of an ontology wherein it would be used in concert with or associated with other classes. This shows one example of classes and structures that could be used to convey meaningful categorization to the user of an embodiment of the system.

FIG. 21 illustrates an example of a categorical ontology that could be integrated with an example embodiment of the invention. Note that this drawing is a visual representation of the hierarchical associations of the ontology and is intended to communicate the structure of the elements of the ontology to a reader, but is not presented in machine readable form. It shows a single class, “Time” which could comprise an entire ontology or only a subset of an ontology wherein it would be used in concert with or associated with other classes. This shows one example of classes and structures that could be used to convey meaningful categorization to the user of an embodiment of the system.

FIG. 22 illustrates a user interface of an example embodiment, showing an inferred categorical casting, that in this case required the user to only type “1980s.” By performing an operation in which the system utilized a collection or ontology not unlike that pictured in FIG. 21 the system selected the category “decade” and applied it to the term. This enables the system to use this query to select artifacts that are associated with the category decade=“1980s.” This enables an embodiment to return artifacts that are categorically relevant to the decade 1980s whether or not the specific text “1980s” appears therein.

FIG. 23 illustrates a user interface of an example embodiment, showing alternate implementation of additional attributes or values that may be associated with a given categorical association.

FIG. 24 illustrates a user interface of an example embodiment, showing an alternate implementation wherein a given term may be associated with multiple categories. In such an embodiment this query may be expressed as: select artifacts where place=“pre-columbian” or time=“pre-columbian.” Of course, the previous sentence assumes an implicit logical relationship between the two categorical selections. As discussed earlier, such an implicit relationship would be exposed or toggle-able within a preferred embodiment, but is eliminated here in order to illustrate multiple possibilities. Accordingly, in such an embodiment this query may also be expressed as: select artifacts where place=“pre-columbian” and time=“pre-columbian.”

FIG. 25 illustrates a user interface of an example embodiment, wherein a process for identifying a term association with the person category has been expressed.

FIG. 26 illustrates a user interface of an example embodiment, wherein a process for identifying two term association with the place category has been expressed.

FIG. 27 illustrates a user interface of an example embodiment, wherein a process for identifying a term association with the activity category has been expressed.

FIG. 28 illustrates a user interface of an example embodiment, not unlike FIG. 24 in that it expresses a simultaneous casting of one term, “lead.” Distinct from FIG. 24, however, is that this particular illustration shows a term that is cast both as a concept and as a keyword. Incorporating all the previous comments regarding the implicit nature of the logical relationship between the two cast categories, this is case where there is one category and one keyword literal. In such an embodiment this query may be expressed as: Select artifacts where metal=“lead” or keyword=“lead.” Another way of expressing the identical query and instance would be: return artifacts that are either topically about lead or contain the text “lead.” With alternate implicit or selected logical relationships between the cast category and keyword literal selections this may be: 1) Select artifacts where metal=“lead” and keyword=“lead.” Another way of expressing the identical query and instance would be: return artifacts that are both topically about lead and contain the text “lead.”

FIG. 29 illustrates a user interface of an example embodiment, showing how multiple categorically cast terms may be combined into one compound query that incorporates keytext and categorical associated terms.

FIG. 30 illustrates a user interface of an example embodiment, showing how multiple categorically cast terms may be combined into one compound query that incorporates keytext and categorical associated terms as well as terms that have been associated with Boolean NOT logic.

FIG. 31 illustrates a user interface of an example embodiment, wherein terms that comprise more than a single word can be used and subsequently have a process triggered, either automatically or by user interaction to split such a term into constituent word or word groups. In some embodiments, the inverse is also enabled.

FIG. 32 illustrates a user interface of an example embodiment, wherein the same techniques discussed in relation to categorical casting can be applied to terms that are entered into a more traditional search form: the simple text box. This embodiment shows the same categorical casting of terms and provides the same enablement of inferred and manual casting. For example, in this illustration the term “Texas Rangers” has been inferred and cast as “organization name.”

### III. System and Method for Query and Result Articulation in Information Retrieval Systems

Various embodiments described herein comprise systems and/or methods for inputting dimensional articulation for search queries and providing multidimensional relevance for artifacts within an information retrieval system. Various embodiments relate to systems and methods for information retrieval (IR), specifically those used for search engines. These kinds of systems and methods can variously be described as being related to facilitating database searching; facilitating the creation of queries and terms related to database searching; facilitating the understanding of queries, terms and results related to database searching; facilitating the presentation or display of queries, terms and results related to database searching; and facilitating human-machine interaction with queries, terms and results related to database searching.

In one embodiment, a set of methods is provided. Some comprise processes for capturing, analyzing and storing evidence regarding artifacts, while others comprise processes for sorting and categorizing artifacts according to behavioral categories. Still others comprise processes for sorting and categorizing artifacts according to content categories. Still others comprise processes for user interaction, enabling users to input dimensionally articulated queries that associate terms with facets associated behavioral and content categories. Still others comprise relevance calculation methods for determining the relevance of a given term to a given facet. Still others comprise machine learning processes for determining the relevance of a given artifact to a given search dimension or facet.

In one example, a system includes a set of modules comprising one or more processors programmed to execute software code retrieved from a computer readable storage medium containing software processes. This system includes a set of search application modules, which support interactions with users for configuring and responding to search queries. The system also includes machine learning modules, which analyze artifact evidence in order to determine relevance to search dimensions.

In another example, a system, or alternatively an apparatus, includes a set of modules or objects having one or more processors programmed to execute software code retrieved from a computer readable storage medium containing software processes. Such software processes are exposed to the user via a user interface, such as that on a display device, for interaction with a user via a pointing device, mouse, touchscreen, keyboard, or other input device. The system or apparatus includes a set of display objects contained within a presentation space. These objects provide presentations of the state of a query as modeled within the apparatus and expose opportunities for interaction from the user with the query in order to provide dimensionally-articulated queries for submittal to the system.

Various embodiments relate to Web-based applications, including, but not limited to Internet search portals. Searching for information or specific artifacts that contain information or other resources on the basis of identifying characteristics, whether on the web or on some other device (computer or smartphone for example), is, for most people, a daily activity. The extension and enhancement of human knowledge and net intelligence fostered by the development and growth of this kind of activity is rivaled only by the invention of the printing press or of written communication itself. The core processes that make this kind of activity possible are best referred to by the term Information Retrieval.

Various definitions that apply to this section are provided above in connection with Section II—Database Search Enhancements. Additional definitions are provided below.

Certain embodiments are described below with reference to block diagrams and operational illustrations of methods and devices to select and present media related to a specific topic. It should be understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

### Segment Modeling of the Internet

For the purpose of this disclosure, the term “segment” connotes a content class that describes an abstract category of desired interaction with information sought by a user; it is an expression of a category of information need; it is also a descriptive of a category of evidence that can be measured or searched for with a query, or measured for a given artifact. A given segment consists of a definition of the type of evidence that would be associated with an artifact that is relevant to the segment. One who is adequately skilled in the art can recognize that the relevance of a given artifact could be measured for a segment definition.

For the purposes of this disclosure the term “segment modeling of the Internet,” “segment model,” or “SMI” connotes a process or system comprising the classification of content and/or information. Any content and/or information accessible via the Internet or any other distributed content storage system can be addressed by the segment model. It is comprised of a system of user modes that content types are assigned to. Segment modeling organizes artifacts by discrete categories that can be utilized by various components of an IR system, such as in the expression of a query, or in the calculation of whether or not a given artifact belongs to a relevance set. Each given category, to which an artifact may or may not belong, is comprised of a definition that describes the denotata of the category and one or more labels or names. The precise relevance of a given artifact to each given category may be scored utilizing known methods such as Clustering, SVM, Bayesian Inference, or similar. The scored relevance is then stored and utilized in order to determine the segment relevance of a given artifact to a given query. Segment modeling is also instantiated in one embodiment by appearing as a selectable option within an IR system UI as a qualifier or attribute for a given term, or alternately as the meaning of the term information within the term. Results are then retrieved from artifacts based on a relative correlation with the associated segment model as expressed within the query. In one embodiment, each category is associated with a specific term that resides in a vocabulary. Embodiments may utilize a fixed vocabulary, but variable vocabulary embodiments are also possible.

Segment modeling can be expressed variably as evidence based upon the source of the association. For example, a given artifact may be described as “shopping” segment content by the publisher, whereas a curator/editor may describe it as “marketing” content. While it may be desirable to weight and sort inputs by source in some implementations, this is not an essential element in all embodiments. In varied variant embodiments, individual sources may be allocated a weight or number of ‘votes’ towards the relevance of a given artifact or artifact set to a given segment, in others a purely algorithmic approach may determine relevance. Blended implementations are also feasible.

In some embodiments segment modeling categorization can result in the application of varied presentation processes for the resulting presentations of artifact associations (formatting of SERPs). For example, SERPs from a “shopping” segment related search may include pricing information for specific items on sale in context with each result item, whereas SERPS from an “academic research” segment related search may include citation statistics in context with each result item. In such embodiments, each segment category will be associated with a specific presentation format for SERPs and or individual results.

For the purposes of this disclosure, and in relation to “SMI” the term “classification of content and/or information” connotes a process or system that engages in a process that analyzes artifacts and produces a quantitative value or values that score its relevance to each segment in a given set of segments. In the context of this term, “classification” is synonymous with categorization; selection; inference; scoring etc.

For the purposes of this disclosure, and in relation to “SMI” the term “addressed by the segment model” connotes the process of analysis and classification of any form of information and artifact by the system utilizing segment modeling. That is, that a given artifact that is analyzed by the IR system is associated with one or more of a given set of segment definitions. That association is stored by the IR system and utilized for the purposes of IR user interactions.

Segment modeling, once applied to a set of artifacts, can then be used as a logical input for a search query. For example, in one embodiment a user could enter the term “shopping” as a term in a query. The system could identify this as an eponymous term, that is, that it is a literal cast of the segment “shopping.” In another embodiment, a given term may not be eponymous with the associated segment. For example the term “ticket” can be associated with the segment “entertainment.” In both cases, these associations may occur as part of a process interaction where the system responds to a given term in an automated fashion, or where the user manually selects a desired association.

A given segment may be used inclusively. For example a user could enter the term “cpa,” and the system presents an eponymous interpretation of that term value with the segment called “accounting services.” The resulting expression of the term within the query is ‘those things associated with accounting services.” This could also be described as a “positive filter.”

A given segment may be used exclusively. For example a user could enter the term “buying,” and the system presents an eponymous interpretation of that term value with the segment called “shopping.” The user could then select to associate a Boolean “NOT” (“disjunctive”) operator with the term. The resulting expression of the term within the query is ‘those things not associated with buying.” This could also be described as a “negative filter.”

A given segment may be used implicitly. For example a user could enter the term “New York Mets” and the system presents an interpretation of the term as “sports team.” The user sees the presentation of the casting, and since that matches the user's information need and intent, need not interact with the system to modify it. This tacit acceptance is an implicit selection to include correlation with such evidence as a parameter of the search.

A given segment may be used explicitly. For example a user could enter the term “truck” and the system presents an interpretation of the term as “transportation.” The user sees the presentation of the casting and since it does not match the user's information need or intent, elects to manually alter the casting and override the segment interpretation of the term value, by interacting with the IR systems UI to select a different segment: “skateboarding.” This manual interaction is an explicit selection to include correlation with such evidence as a parameter of the search.

An embodiment may utilize one or more vocabularies to represent segment sets. For example the term values “ticket,” “admission,” and “passage” may be included with one vocabulary, and within that vocabulary be associated with the “travel” segment. In a second vocabulary the term “passage” may be associated with the “literature” segment. Specific implementations of the embodiment may utilize varied rules to determine which specific interpretation of “passage” may be automatically applied or presented for disambiguation prompting of the user when entered as a search term value, such as term relevance to segment, semantic scoring of all terms entered and combinations thereof.

For the purposes of this disclosure, and in relation to “SMI” the term “segment relevance” connotes the degree to which the information in a given artifact can be said to be related to a given segment definition. In the context of casting terms as associated with a given segment it can also connote the degree to which a given term is likely to refer to a given segment definition when input as a term value by a search user.

### Quintuple Tier Relevance

For the purposes of this disclosure the term “relevancy tier” or simply “tier” connotes a specific category of information meaning that correlates with a particular kind of artifact or information. This is, generally synonymous with the terms “dimension,” “search dimension,” or “facet.” These categories of meaning can be thought of as inclusive or exclusive filters that can be incorporated into search tools. One embodiment utilizes quintuple tier relevance to enhance the dimensional articulation of the associated IR system. In this implementation, five key types of categorical evidence are identified for each artifact, including: content; links to content; editorial description; content provider description; and active html.

For the purposes of this disclosure the term “quintuple tier relevance,” “QTR,” or “5TR” connotes the determination of artifact relevance to a given search utilizing five or fewer categories of dimensions, comprising those associated with “content,” “links to content,” “editorial description,” “content provider description,” and “active html.”All five categories of information are evidence about a given artifact or set of artifacts.

For the purposes of this disclosure, and in relation to “5TR” the term “content” connotes evidence regarding the information contained in a given artifact, including that which is visible to a human viewer of the medium or document the artifact is stored in, as well as that which is invisible to a human viewer, but is stored or transmitted as part of retrieving the artifact from its given location by the IR system. This also includes contextual information and other forms of evidence that are observable regarding the artifact such as header information or URI.

For the purposes of this disclosure, and in relation to “5TR” the term “links to content” connotes evidence that refers to given artifact that is located within other artifacts. This may include the presence or absence of the URI of the artifact; an implicit or explicit hyperlink to the artifact; the text representation to which the implicit or explicit link is associated.

For the purposes of this disclosure, and in relation to “5TR” the term “editorial description” connotes evidence about a given artifact that is provided, produced or generated by human actors that are not directly associated with the producer, publisher or creator of the artifact. In ideal embodiments standards of objectivity will be applied to the production of this evidence. This evidence includes, but is not limited to: segment association; association with taxonomic classes; tag associations; keyword associations; vocabulary associations; vocabulary subset associations; appropriate audience definitions. Note that the associations mentioned in the prior list may be exclusive or inclusive, or weighted scores with one or more representations.

For the purposes of this disclosure, and in relation to “5TR” the term “content provider description” connotes evidence about a given artifact that is provided produced or generated by human actors that are, or are directly associated with the product, publisher or creator of the artifact. This evidence includes, but is not limited to: segment association; association with taxonomic classes; tag associations; keyword associations; vocabulary associations; vocabulary subset associations. Note that the associations mentioned in the prior list may be exclusive or inclusive, or weighted scores with one or more representations.

For the purposes of this disclosure, and in relation to “5TR” the term “active html” connotes evidence about a given artifact that is provided within the document itself in a manner that is usually invisible to a casual human observer of the document (e.g., via a browser over the Internet) but provides specific evidence that is intended to affect how the artifact is analyzed by an IR system. This evidence includes, but is not limited to: segment association; association with taxonomic classes; tag associations; keyword associations; vocabulary associations; vocabulary subset associations and semantic tagging or semantic tag hinting or semantic tag inference. Note that the associations mentioned in the prior list may be exclusive or inclusive, or weighted scores with one or more representations.

### Multiple Tier Relevance

For the purposes of this disclosure the term “multiple tier relevance” or “MTR” connotes the measurement of artifact relevance to a given search utilizing two or more categories of dimensions, including, but not limited to “content,” “links to content,” “editorial description,” “content provider description,” and “active html.” All such categories of information are evidence about a given artifact or set of artifacts.

### Real Time Search Visualization

For the purposes of this disclosure the term “real time search visualization” or “RTSV” connotes a system and process by which a person searching for information can obtain real-time feedback to the logic, terms and nature of the search they are constructing within a search engine. The feedback provided can be by any means provided for by the computer interface, including text, graphics, animation, video, audio, etc. RTSV is a means by which a search engine user interface can be enhanced. The primary use of RTSV is to build a logical diagram of the search being created by the user as terms are being entered into an IR system. The logical diagram will provide a logical set illustration of the following: the terms being searched for; the logical relationship of the terms; possible flaws in the search. RTSV provides a base logical descriptor language that makes the search translatable into a number of types of visual presentations including 2-dimensional, 3-dimensional, set theory, logical diagrams, etc. RTSV provides the user the ability to recognize problems in the search, both logical and information oriented, earlier than traditional term input methods, including before the query is submitted to the IR system, during and after the IR system has presented results to the user.

For the purposes of this disclosure, and in relation to “RTSV” the term “real-time” or “real time” connotes machine human interactions comprising representations made to the human user of a computing system that occur so rapidly as to have little or no meaningful distinction between the duration taken to perform the presentation and instaneity. In actual practice the amount of time consumed by a computing system to provide feedback; for example, to accept input, process the input, retrieve usable data, analyze input and retrieved data and assemble and present a response is significantly greater than zero. The real time consumed between input and presentation may range from millisecond or smaller periods and may range up to periods in excess of dozens of seconds. In an ideal situation, such processes will take less than a fraction of a second, such ideal performance is not always possible and response times often may take several seconds. Another approach to understanding what is intended by “real time” is to understand it within the context of the process to which it is applied. In that manner it is intended to imply a scenario where the presentation of feedback information is presented to the user after some form of user term input, but prior to the full completion of a given query submittal, so that the user has the opportunity to consider feedback prior to the submittal of a complete query. In this way, these real-time presentations can be thought of as interruptions to the process of the user entering terms and term meta-data into an IR system.

For the purposes of this disclosure, and in relation to “RTSV” the term “feedback” connotes machine human interactions of an IR system that communicate information about a query, the terms comprising that query, the search dimensions associated with each term, the logical operators or expressions associated with each term, or associated with an entire query, or a set of terms contained within a query. These presentations may take place via any hardware or software output device. In an ideal embodiment these presentations occur via visual or auditory presentations via sound or graphical devices such as a screen and/or speakers. In a typical embodiment these presentations will include on-screen color, text or other information or drawings made in visual context to the information comprising the on-screen representation of the input term information.

For the purposes of this disclosure, and in relation to “RTSV” the term “real-time feedback” connotes feedback that occurs within the scope of real-time.

For the purposes of this disclosure, and in relation to “RTSV” the term “logical set illustration” connotes a presentation via a form of graphical or other type of output device of a query and its constituent terms. The terms comprising that query, the search dimensions associated with each term, the logical operators or expressions associated with each term, or associated with an entire query, or a set of terms contained within a query. In an ideal embodiment this will comprise a visual diagram denoting each term; one or more, if any, logical operators or logical expressions associated with each term; one or more, if any, search dimension or tiers associated with each term; one or more, if any, suggested term disambiguation options for each term; one or more, if any, suggested logical disambiguation options for each logical association, one or more, if any, suggested dimensional disambiguation options for each dimensional association; the implications of term disambiguation selections for any associated search dimensions or associated logical operators or expressions; the implications of logical disambiguation selections for any associated terms or associated dimensions for each term; the implications of dimension selections for any associated terms or associated logical operators or expressions.

For the purposes of this disclosure, and in relation to “RTSV” the term “logical set illustration of the terms being searched for” connotes the presentation of the information within each term that comprises a query in context with the logical operators or expressions that have been applied to each term, and/or to sets of terms within the query. Logical operators or expressions that are utilized in the ideal embodiment include, but are not limited to: union; intersection; set difference; symmetric difference; Cartesian product; power set; conjunction; disjunction; and negation.

For the purposes of this disclosure, and in relation to “RTSV” the term “logical relationship of the terms” or “logical set illustration of . . . logical relationship of the terms” connotes the presentation of the logical operators or expressions that are associated with each term or set of terms that comprise a query, in context with the terms with which they are associated. It also connotes the presentation of any ontological classes, search dimensions, or other category names that are associated with a given term, in context with the terms with which they are associated.

For the purposes of this disclosure, and in relation to “RTSV” the term “possible flaws in the search” or “logical set illustration of . . . possible flaws in the search” or “means to enhance the search” or “logical set illustration of . . . means to enhance the search” connotes the presentation of: various forms of information regarding potential flaws in a given query, for example mutually exclusive terms “cat” and “(not) cat”; various forms of suggested additional terms that may decrease the number of results given present terms; various forms of suggested additional terms that are related to the present terms; various forms of suggested additional terms that clarify or create a specific association with a specific denotata of a given term, or a set of terms; various forms of suggested alternate ontological categories that may alter or narrow the search; suggested logical operators or expressions that may alter or narrow the search; various forms of spelling-correction suggestions; various forms of homonym lists that may more accurately represent the denotata underlying the information need of the user; various forms of term and definition pair lists that may more accurately represent the denotata underlying the information need of a the user.

For the purposes of this disclosure, and in relation to “RTSV” the term “logical oriented” connotes the characteristics of a given query or subset of the terms within a query as regards any associated logical operator(s) or logical expressions(s).

For the purposes of this disclosure, and in relation to “RTSV” the term “information oriented” connotes the characteristics of a given query or subset of the terms within a query as regards the information contained within each term.

### Ontological Modeling of the Internet

For the purposes of this disclosure the term “taxonomic modeling of the Internet,” o “taxonomic model,” or “TMI” connotes a classification system for information contained within one or more artifacts. Any content or information accessible via the Internet or any other machine addressable and retrievable set of artifacts can be addressed by the system and process previously labeled as the Taxonomic Model. While a taxonomic implementation of the present invention is representative of extant embodiments, the essential definitions and intent of the invention are in fact better described as utilizing an ontology, rather than a taxonomy. When the terms “taxonomic modeling of the Internet,” taxonomic model,” or “TMI” are encountered, they should be considered on their own merit, in the context of an embodiment, as well as placeholders for the terms “ontological modeling of the Internet”, “ontological model,” or “OMI.”

For the purposes of this disclosure the term “ontological modeling of the Internet,” “ontological model” or “OMI” connotes a classification and organization system for information contained within one or more artifacts; this term supersedes the terms “taxonomic modeling of the Internet,” “taxonomic model,” and “TMI.” Any content or information accessible via the Internet or any other machine addressable and retrievable set of artifacts can be addressed by the Ontological Model. OMI is comprised of a set of classes of content, each of which may be divided, and further subdivided into sub-classes and sub-sub-classes and so on, continually to finer and more focused levels. One ideal embodiment has four layers of classes, another two. While OMI has other useful applications, its disclosure here is primarily concerned with utilization as part of an IR system. In one embodiment, OMI evaluates a given artifact and evaluates it as to what classes it may or may not belong to by scoring its relevance to each category. System configuration settings, or class definitions may set relevance score bounds that define whether a given artifact may be considered as belonging “in” or “out” of a given category. In other embodiments OMI stores a relevance score for each artifact, for each possible class or sub-class. A given artifact may thus be categorized (i.e., “belong to” or be associated with) more than one class and or sub-class. In most embodiments the definition of a given class cannot share the same sub-classes of any other class (i.e., the class structure is exclusive). However, a given IT system may utilize one or more OMI structures. In such an implementation, OMI structure “A” may include the same or similar definitions of a given sub-class with OMI structure “B,” yet include that definition in a different topology location. For example, one OMI structure may include the “Ford” subclass as a child of the “automobile manufacturer” class where another OMI structure may include the “Ford” subclass as a child of the “Truck Maker” class. Both OMI structures could be used within the same IR system, and a given artifact may have scored associations with multiple classes within each OMI structure.

For the purposes of this disclosure, and in relation to “OMI” the term “classification of content and/or information” connotes the association of a given artifact or denotata contained within an artifact with a degree of relevance (which may be null or zero) to a given search dimension.

For the purposes of this disclosure, and in relation to “OMI” the term “addressed by the taxonomic model” connotes either or both the process of, or data stored representing the classification of content and information of one or more artifacts within one or more ontologies or other categorization structures.

### Description of Additional Example Embodiments

Certain embodiments include a process for calculating the relevancy of a given artifact or the relevancy of the evidence associated with a particular artifact in a potential result set based on a set of categories of evidence (search dimensions); multiple tier relevancy.

FIG. 1 illustrates one embodiment of a summation for the relevance of an artifact for a variable number of component relevancies (or dimensions) where g is the artifact relevance for a given artifact x, i is the number of component relevancies and n₁ through nᵢ indicate component relevancies 1 through i, and where, for each component relevancy, dᵣ indicates a dimensional relevancy value, dᵤ indicates the Boolean use value expressed by the user for the accompanying relevancy value, and where, for each artifact, relevancy is the sum of total relevancy values (n₁ through nᵢ) for the given relevancy set. 5TR is an embodiment that utilizes this method for five specific categories of evidence. This figure could alternatively be expressed in text as “g.sub.x=i.SIGMA.n=1 (d.sub.r*d.sub.u).sub.n.sub.i=(d.sub.r*d.sub.u).sub.n.sub.1+ . . . +(d.sub.r*d.sub.u).sub.n.sub.i.”

In one example, the five key categories of relevance are compounded to calculate the relevance of a given artifact to a given query utilizing the formula illustrated in FIG. 2, where, for each artifact n, relevance Xₙ is calculated using the following: cₙ is the base content relevance (a measure of the content evidence); lₙ is the link or citation relevance (a measure of the links to content evidence); eₙ is the editorial relevance (a measure of the editorial description evidence); pₙ is the provider relevance (a measure of the content provider description evidence); aₙ is the active html relevance (a measure of the active html evidence). Each of these relevancies is a real number that is part of any generalized number scale such as 1 to 10 or 0.001 to 1. FIG. 2 could alternatively be expressed in text as “x.sub.n=c.sub.n+1.sub.si+e.sub.n+p.sub.n+a.sub.n.”

In one example, the five key categories of relevance are compounded on the basis of whether or not they have been selected by the user to be included for the determination of relevance of a given artifact. The formula illustrated in FIG. 3 shows such a calculation from this embodiment, where, for each artifact n, relevance Xₙ, given user input u, is calculated using the following: cₙ is the base content relevance (a measure of the content evidence); cᵤ is the Boolean use value for base content relevance (where 1 means to use this measure and 0 to not use this measure); lₙ is the link or citation relevance (a measure of the links to content evidence); lᵤ is the boolean use value for link or citation relevance (where 1 means to use this measure and 0 to not use this measure); eₙ is the editorial relevance (a measure of the editorial description evidence); eᵤ is the Boolean use value for editorial relevance (where 1 means to use this measure and 0 to not use this measure); pₙ is the provider relevance (a measure of the content provider description evidence); pᵤ is the Boolean use value for provider relevance (where 1 means to use this measure and 0 to not use this measure); aₙ is the active html relevance (a measure of the active html evidence); aᵤ is the Boolean use value for active html relevance (where 1 means to use this measure and 0 to not use this measure). Bach of these relevancies is a real number that is part of any generalized number scale such as 1 to 10 or 0.001 to 1. FIG. 3 could alternatively be expressed in text as “x.sub.n=(c.sub.n*c.sub.u)+(l.sub.n*l.sub.u)+(e.sub.n*e.sub.u)+(p.sub.n*p.sub.u)+(a.sub.n*a.sub.u).”

Boolean values may be set utilizing user preference data that is loaded by IR system modules, or by input tacitly or explicitly provided by the user at the time of query input, using such common and traditional means as checkboxes, radio buttons, etc. The inclusion of Boolean use values within the relevance calculations provides the ability for a user to select to utilize evidence from one or more categories within a given search. The inclusion of Boolean use values within the relevance calculations provides the ability for a user to ignore or discard evidence from one or more categories within a given search. Both of these cases are examples of dimensional articulation utilizing 5TR.

FIG. 4 illustrates an MTR artifact analysis process in an embodiment of the present invention. The system begins with the selection of an artifact for analysis 401. The system proceeds to observe, generate and store evidence associated with the selected artifact, first related to the human-readable information within the artifact 402, including tokenization, semantic analysis, and other means of creating data representations of the artifact that are optimized for subsequent IR processes. Information evidence is scored for relevance via SMI and via OMI. Next, the system generates evidence based on evaluation of citation evidence 403, including tabulations of known citations, links, and the information contained in known citations and links. Citation evidence is scored for relevance via SMI and via OMI. Next, the system evaluates information contained in non-human readable components of the artifact (for example, meta-data and HTML semantic tags, tag classes and similar) 404. Citation evidence is scored for relevance via SMI and via OMI. Next, the system selects any available editorial evidence 405; in at least one embodiment, this is comprised of OMI and SMI association selections made by an objective human curator; in alternate embodiments this could be an aggregate of a plurality of a set of human selected associations. Preferably, this data would exist at the time of analysis 410; if so, the existing selections will be utilized 411; if not, additional task management modules could be utilized to prompt, request and/or remind human actors to provide these selections 412. Next, the system selects any available provider evidence 406; in the ideal embodiment this is comprised of OMI and SMI association selections made by a human actor representing the publisher, creator or distributor of the artifact; in alternate embodiments this could be an aggregate of a plurality of a set of human selected associations. Preferably, this data would exist at the time of analysis (e.g. via crawling request) 410; if so, the existing selections will be utilized 411; if not, additional task management modules could be utilized to prompt, request and/or remind human actors to provide these selections 412. Finally, after all evidence has been generated and collected it is stored by the system 407, so that it can be utilized for search query interactions.

FIG. 5 illustrates MTR module and storage relationships in an embodiment of the present invention. The process begins with the retrieval of an artifact 501, which is performed by a retrieval module 511 and results in evidence stored in a data store 516. Next, the artifact is analyzed 502; for information relevance to SMI and OMI classes; for citation relevance to SMI and OMI classes; and for active content relevance to SMI and OMI classes. In this example, this analysis is performed by a machine learning module 512, which stores the resulting evidence in a data store 516. Next, the system selects any extant provider evidence records 503; provider evidence comprises SMI and OMI class selections made by human actors, associated with the target artifact, on the behalf of the content owner, creator or publisher; if such evidence exists, it is integrated with the stored data by a curatorial evidence module 513; if it does not exist, a curatorial elicitation module is activated, which initiates a process to contact an appropriate human actor and request the SMI OMI selections; additionally, based on whether or not such information exists, and according to the rules of the implementation, a scheduler module 514 will schedule a new process cycle for a future time to determine if new evidence has been selected by a human actor. Next, the system selects any extant editorial evidence records 504; editorial evidence comprises SMI and OMI class selections made by an objective human actor or actors, associated with the target artifact. Whether or not editorial records exist will prompt the same process response via a curatorial evidence module 513, a curatorial elicitation module 514, and a scheduler module 515 as that described for 503, with editorial actors substituted for provider actors. When collected, the provider and editorial evidence is stored in the data store 516.

FIG. 6 illustrates a facet casting presentation apparatus for an embodiment of real time search visualization; demonstrating constituent elements of objects presented on one or more display devices, suitable for interaction with and by a user via a pointing device, keyboard, touchscreen or other means. This embodiment is suitable, for example, for implementation with any number of technologies, examples of which include, but are not limited to: Java, PHP, HTML, Actionscript, Javascript, etc. Interaction space 610 represents the total visual presentation area available for use by the IR system UI. The essential elements within this space for the current invention include the following objects. The query logic presentation object 611 displays information regarding logical expressions which are applied to the total set of current search terms. Such expressions include union, intersection, set difference, symmetric difference, Cartesian product, power set, conjunction, disjunction and negation; the current selected expression has a compound effect over any logic object expression selections that may exist in the term wrapper object 620. For example if the query logic object contained a negation expression selection and the query contained two terms: “boats,” also with a negation selection; and “cars,” with a conjunction selection; the system would return a selection of items that are “the negation of (‘all items that are cars but not boats’)” or “all items not cars that are boats” which may represent the information need “all boats other than amphibious cars.” Alternate embodiments may include multiple query logic objects with associations that span one or more terms within a larger query set. The query logic interaction object 612 handles the presentation, display states and display processes of interactions related to the current selected logical expression associated with the query (or an associated set of terms within the query); managing the states and processes of a variety of interactions including: interaction events such as clicking, dragging, swiping, hovering, tapping, etc.; discriminating discrete interaction events such as selection, focus handling, de-selection, presentation of all possible logic selections, empty or null logic, selection of alternate logic selections, requests for additional information regarding associated term interpretation given the current logic object, requests for information regarding alternate logic selections. The term wrapper 620 handles presentation to and interactions with the user related to a given term; multiple instances of this object may occur within the system, one for each term in the query. Additionally, this object is utilized to indicate to the user when the addition of a new term is possible. This is a compound object containing several sub-components: the term presentation object 621; the term interaction object 622; the facet presentation object 623; the facet interaction object 624; the logic presentation object 625; and the logic interaction object 626.

The term presentation object 621 conveys information about the current term to the user and presents visual elements for receiving user interactions with the term, including: the information contained within the term; whether or not there is any information contained in the term; if the term is ambiguous; alternate term selections or modifications that may eliminate ambiguity (suggestions); how the constituent parts of the term may be parsed into one or more additional terms; how the term may be combined with other terms to form a less ambiguous query with fewer terms; how to remove the term from the query, presentation of how the current term or alternate terms will be interpreted by the IR system, information conveyance regarding the concepts or entities associated with given interpretations of the current term.

The term interaction object 622 manages the states and processes of a variety of interactions with the term including: interaction events such as clicking, dragging, swiping, hovering, tapping, etc.; discriminating discrete interaction events such as selection, focus handling, de-selection, presentation as a new, empty term, selection of alternate term selections, requests for additional information regarding term interpretations, requests for information regarding alternate term selections, manually splitting a compound (multiple words or other components of information) into multiple terms, manually combining the term with another term to form a new compound term.

The facet presentation object 623 conveys information about the facet, which is currently applied to an associated term to the user, and presents visual elements for receiving user interactions with the facet, including: the information contained within the facet; whether or not there is any information contained within the facet; if the facet is ambiguous; alternate facet selections or modifications that may eliminate ambiguity (suggestions).

The facet interaction object 624 manages the states and processes of a variety of interactions with the facet including: interaction events such as clicking, dragging, swiping, hovering, tapping, etc.; discriminating discrete interaction events such as selection, focus handling, de-selection, presentation of all possible facet selections, empty or null facet, selection of alternate facet selections, requests for additional information regarding associated term interpretation given the current facet, requests for information regarding alternate facet selections, facet implications of manually splitting an associated term into multiple terms, facet implications of manually combining an associated term with another term.

The logic presentation object 625 conveys information about one or more logical expressions that are currently applied to the associated term to the user, and presents visual elements for receiving user interactions with the logic object, including: the information contained within the logic object; whether or not there is any information contained within the logic object; if the logic is ambiguous; alternate logic selections or modifications that may eliminate ambiguity (suggestions).

The logic interaction object 626 manages the states and processes of a variety of interactions with the logic object including: interaction events such as clicking, dragging, swiping, hovering, tapping, etc.; discriminating discrete interaction events such as selection, focus handling, de-selection, presentation of all possible logic selections, empty or null logic, selection of alternate logic selections, requests for additional information regarding associated term interpretation given the current logic object, requests for information regarding alternate logic selections, logic implications of manually splitting associated terms into multiple terms, logic implications of manually combining associated terms with other terms.

FIG. 7 illustrates a facet casting presentation apparatus for an alternate embodiment of real time search visualization; demonstrating constituent elements of objects presented on one or more display devices, suitable for interaction with and by a user via a pointing device, keyboard, touchscreen or other means. This embodiment is suitable for implementation with any number of technologies, examples of which include, but are not limited to: Java, PHP, HTML, Actionscript, Javascript, etc. Interaction space 710 represents the total visual presentation area available for use by the IR system UI. The essential elements within this space for the current invention include the following objects. The query logic presentation object 711 displays information regarding logical expressions which are applied to the total set of current search terms. Such expressions include union, intersection, set difference, symmetric difference, Cartesian product, power set, conjunction, disjunction and negation; the current selected expression has a compound effect over any logic object expression selections that may exist in the term wrapper object 720. For example, if the query logic object contained a negation expression selection and the query contained two terms: “boats,” also with a negation selection; and “cars,” with a conjunction selection; the system would return a selection of items that are “the negation of (‘all items that are cars but not boats’)” or “all items not cars that are boats” which may represent the information need “all boats other than amphibious cars.” Alternate embodiments may include multiple query logic objects with associations that span one or more terms within a larger query set. The query logic interaction object 712 handles the presentation, display states and display processes of interactions related to the current selected logical expression associated with the query (or an associated set of terms within the query); managing the states and processes of a variety of interactions including: interaction events such as clicking, dragging, swiping, hovering, tapping, etc.; discriminating discrete interaction events such as selection, focus handling, de-selection, presentation of all possible logic selections, empty or null logic, selection of alternate logic selections, requests for additional information regarding associated term interpretation given the current logic object, requests for information regarding alternate logic selections. The term wrappers 720,730 handle presentation to and interactions with the user related to a given term (term “A” and term “B”); multiple instances of these objects may occur within the system, one for each term in the query. Additionally, this object is utilized to indicate to the user when the addition of a new term is possible. This is a compound object containing several sub-components: the term presentation object 721,731; the term interaction object 722,732; the facet presentation object 723; the facet interaction object 724,734; the logic presentation object 725,735; and the logic interaction object 726,736.

The term presentation object 721,731 conveys information about the current term to the user and presents visual elements for receiving user interactions with the term, including: the information contained within the term; whether or not there is any information contained in the term; if the term is ambiguous; alternate term selections or modifications that may eliminate ambiguity (suggestions); how the constituent parts of the term may be parsed into one or more additional terms; how the term may be combined with other terms to form a less ambiguous query with fewer terms; how to remove the term from the query, presentation of how the current term or alternate terms will be interpreted by the IR system, information conveyance regarding the concepts or entities associated with given interpretations of the current term.

The term interaction object 722,732 manages the states and processes of a variety of interactions with the term including: interaction events such as clicking, dragging, swiping, hovering, tapping, etc.; discriminating discrete interaction events such as selection, focus handling, de-selection, presentation as a new, empty term, selection of alternate term selections, requests for additional information regarding term interpretations, requests for information regarding alternate term selections, manually splitting a compound (multiple words or other components of information) into multiple terms, manually combining the term with another term to form a new compound term.

The facet presentation object 723,733 conveys information about the facet, that is currently applied to an associated term to the user, and presents visual elements for receiving user interactions with the facet, including: the information contained within the facet; whether or not there is any information contained within the facet; if the facet is ambiguous; alternate facet selections or modifications that may eliminate ambiguity (suggestions).

The facet interaction object 724,734 manages the states and processes of a variety of interactions with the facet including: interaction events such as clicking, dragging, swiping, hovering, tapping, etc.; discriminating discrete interaction events such as selection, focus handling, de-selection, presentation of all possible facet selections, empty or null facet, selection of alternate facet selections, requests for additional information regarding associated term interpretation given the current facet, requests for information regarding alternate facet selections, facet implications of manually splitting an associated term into multiple terms, facet implications of manually combining an associated term with another term.

The logic presentation object 725,735 conveys information about one or more logical expressions that are currently applied to the associated term to the user, and presents visual elements for receiving user interactions with the logic object, including: the information contained within the logic object; whether or not there is any information contained within the logic object; if the logic is ambiguous; alternate logic selections or modifications that may eliminate ambiguity (suggestions).

The logic interaction object 726,736 manages the states and processes of a variety of interactions with the logic object including: interaction events such as clicking, dragging, swiping, hovering, tapping, etc.; discriminating discrete interaction events such as selection, focus handling, de-selection, presentation of all possible logic selections, empty or null logic, selection of alternate logic selections, requests for additional information regarding associated term interpretation given the current logic object, requests for information regarding alternate logic selections, logic implications of manually splitting associated terms into multiple terms, logic implications of manually combining associated terms with other terms.

Term wrapper presentations will present a visual representation of logical association 740 between terms (in the case of this diagram {A,B}, but could also be of larger sets, e.g. {A,B,C,D}, not pictured); this may take various forms, including that of an intersecting or overlapping area (as in a Venn diagram), a connecting line or lines, usage of color or pattern where particular colors or patterns are keyed to specific forms of logical relationships between or among terms.

FIG. 8 illustrates an architectural diagram of an embodiment of the present invention. This includes a search application server 801 that handles query interactions with search users 831 as well as authentication and other services to support user interactions. Such modules comprise one or more processors programmed to execute software code retrieved from a computer readable storage medium containing embodiments of software with processes for handling user interactions for search and related functionality. Interactions between the search application server and users occur across a network or networks 811, usually, but not exclusively, the Internet and/or other contiguous networks, via various devices 821-823, including but not limited to, computers, smartphones, PDAs, and other devices. The application server utilizes, updates and generates data stored in a data store 805; communication between the server and data store occurs over a network or networks 812, which may or may not correspond with the network or networks illustrated as 811. The machine learning server 802 handles machine learning modules, which utilize, update and generate data stored in the data store 005; communication between the server and data stores occurs over a network or networks 812, which may or may not correspond with the network or networks illustrated as 811. Machine learning modules generate inference data regarding artifacts that are retrieved by the retrieval server 803 such as associations with SMI and OMI classes (between artifacts and such classes or denotata within artifacts and such classes). Such modules comprise one or more processors programmed to execute software code retrieved from a computer readable storage medium containing embodiments of software with processes for executing machine learning analysis of selected artifacts. The retrieval server 803 runs modules that retrieve artifacts (crawl) and generate evidence regarding artifacts (analyze); it stores, updates and creates data in the data store [805], including evidence regarding artifacts and artifact representations. Such modules comprising one or more processors programmed to execute software code retrieved from a computer readable storage medium containing embodiments of software with processes for addressing and retrieving remote network resources and artifacts, and analyzing and storing the same. Retrieved artifacts are served by content servers 804 which are contacted across a network or networks 813, usually comprised of the Internet and, optionally, other contiguous or remote networks, which may or may not correspond with the network or networks illustrated as 811.

FIG. 9 illustrates an OMI data source and storage related process overview of an example embodiment. This process begins when a retrieval module 913 selects one or more artifact representations, stored in an artifact data store 923 and retrieves the associated artifacts 901 from one or more remote content servers (not pictured). Next, an analysis module 912 examines each artifact and extracts component evidence, based on stored definition data 922, may be tokenized, and is subsequently stored 903 in an artifact data store 923, associated with the origin artifact. Stored definition data is comprised of, but not limited to facet definitions, token definitions, sign definitions and denotata definitions. Next, an analysis module 911 examines each artifact and determines the degree to which the given artifact is relevant to each facet 903, based on stored training data 921 and stored definition data 922. Further, in at least one embodiment, each artifact may be analyzed to generate a list of each denotata contained within the artifact, the degree to which a given denotata is relevant to the total information contained within the artifact, and the degree to which each denotata is relevant to each facet (i.e., search dimension) also based on stored training data 921 and stored definition data 922. Variant embodiments may update or identify new training data as part of this analysis process. Finally, all resultant artifact evidence is stored, which may be in the same artifact data store 923 or some other store, not pictured.

Once handled by the above steps of the process, artifacts are now addressable for the purposes of handling queries submitted into the system. Queries are the result of searches created by users interacting with the system 931. The human-machine interactions that create queries result in the selection of facets associated with terms or term sets 932 as well as sign and/or denotata associations. These associations link specific terms or term sets with facet, sign and denotata records in stored definition data 922, permitting the calculation of the relevance of artifacts previously evaluated by the system vis-a-vis the submitted query 933, by the search module 914. The most relevant artifacts are returned to the user 934.

Various embodiments can associate a given artifact with a given dimension based on a manual selection. In at least one example, the system also evaluates each artifact, or each denotata within a given artifact for relevance characteristics within a set of standardized facets.

FIG. 10 illustrates machine learning categorization for fixed ontology of at least one embodiment, applied to a specific ontology. While this illustration addresses artifacts, it should be understood to be addressable to specific denotata within any artifact as well. An artifact is retrieved by the system 1001 and then prepared for analysis 1002, which is comprised of various methods to extract content information from the artifact, assemble meta information about the artifact, and may include tokenization or other methods to reduce the information to its simplest state without destroying information. The system then engages in ontological analysis 1003 of the information contained within the artifact, which is generally comprised of, for each dimension: assembling a list of all meaningful terms that comprise the artifact; assembling a list of semantic equivalencies that can be associated with the listed terms; assembling a list of terms for which dimensional relevance can be measured; measuring the relevance for each relevant term; measuring the relative portion of the information of the artifact that is relevant to the term; if the ontology contains sub-classes, repeat the process for each sub-class. When analysis is complete, the system stores the generated evidence 1005. In regard to the pictured example, a specific abstract ontology is represented. This ontology includes the following root classes 1004: A, B and C.

At least one embodiment uses the following ontology classes: Keytext; Individual; Entity; Subject; Segment; Form; Time; Place; Activity; Event; Object; Theme. These classes have the following definitions: Keytext connotes a term without any specific dimensional association. All meaningful terms within the artifact are keytext terms. For the purpose of this embodiment, the term “meaningful term” connotes individual words and identifiable entity names that can be observed within the content other than any words that are included in a stop-words list (words that have been identified as meaningless for the purposes of search such as “the”). “Individual” connotes a term that is the name of a real, living, deceased or fictional person or creature. This includes single terms, or compound (multiple-word) terms, in the various forms and structures in which human names can occur. Nicknames, aliases, and other forms of names and titles that are synonymous with the same person or creature are included. (e.g., “George Carlin,” “Bach,” or “Darth Vader”). “Entity” connotes a term that is the name of an organization, movement, company, government or religion or other group of people that can be referred to by a name. (e.g., “IRS,” “The Beatles,” or “Archer Daniel Midland”) “Subject” connotes an area of knowledge, study, information, discipline, practice or other unitary body of information (e.g., “pottery,” “physics,” or “informatics”). “Segment” connotes a discrete type of form of activity or content (e.g., “shopping,” “software,” or “real estate”). “Form” connotes the physical or digital medium, format or type of a thing (e.g., “audio,” “PDF,” or “granite”). “Time” connotes a time, date, a range of either, or the name of a particular era or period of time. “Place” connotes a real or fictional location (“London,” “Kauii,” or “Middle Earth”). “Activity” connotes an occupation, hobby, pastime, or Interest (e.g., “physics,” “karate,” or “nursing”). “Event” connotes a future, planned, historical or recurring event (e.g., “bastille day,” “San Diego Comic Con,” or “D-Day”). “Object” connotes a specific object, creative work, building or artifact (e.g., “Space Shuttle Endeavor,” “Chrysler Building,” or “Mona Lisa”). “Theme” connotes a custom or standardized category for any type of content, which in some implementations is synonymous with or includes channels, and in other implementations does not. All terms may be comprised of multiple or single words. All terms have, within and across dimensions, the potential to be associated with other terms. Associations between terms may define various forms of relationship, including, but not limited to: synonymous (referring to the same underlying meaning; referring to the same underlying entity, person, creature, place, object, theme, time, subject, segment, form, activity or event); explicitly not synonymous; partially synonymous (may be weighted); related (various forms of relationship may also be indicated).

FIG. 11 illustrates a machine learning process for variable ontology in an embodiment of the present invention. The pictured embodiment is a variant of the process illustrated in FIG. 10 that utilizes a variable number of ontology root classes or a specified set of classes from any level. While this illustration addresses artifacts, it should be understood to be addressable to specific denotata within any artifact as well. An artifact is retrieved by the system 1101 and then prepared for analysis 1102, which is comprised of various methods to extract content information from the artifact, assemble meta information about the artifact, and may include tokenization or other methods to reduce the information to its simplest state without destroying information. The system then engages in ontological analysis 1103 of the information contained within the artifact, which is generally comprised of, for each dimension: assembling a list of all meaningful terms that comprise the artifact; assembling a list of semantic equivalencies that can be associated with the listed terms; assembling a list of terms for which dimensional relevance can be measured; measuring the relevance for each relevant term; measuring the relative portion of the information of the artifact that is relevant to the term; if the ontology contains sub-classes, repeat the process for each sub-class.

When analysis is complete, the system stores the generated evidence 1105. The system completes this cycle for each dimension (class) utilized in the implementation, determining after the analysis of each dimension if there are any remaining classes to be analyzed 1106, if so it proceeds to the next class 1103, otherwise the process ends 1107. In regard to the pictured embodiment, an abstract ontology is represented that is comprised of N number of root classes, each of which are evaluated for relevance to the artifact.

Various embodiments can associate a given artifact with a given dimension based on a manual selection. In one example, the system also evaluates each artifact, or each denotata within a given artifact for relevance characteristics within a set of standardized facets. The associated dimension may be comprised of content categorization, such as that described in the context of OMI, or they may be comprised of categories that are distinguished by different forms of interactive behaviors that users may undertake with associated content, or interactive expectations of users with associated content. This latter form of categorization is performed within an embodiment of SMI.

FIG. 12 illustrates machine learning categorization for fixed segment set of an embodiment of the present invention, applied to an exemplary set of segments. An artifact is retrieved by the system 1201 and then prepared for analysis 1202, which is comprised of various methods to extract content information from the artifact, assemble meta-information about the artifact, and may include tokenization or other methods to reduce the information to its simplest state without destroying information. The system then engages in segment analysis 1203 of the information contained within the artifact, which is generally comprised of, for each segment: assembling a list of all meaningful indicia that comprise the artifact; assembling a list of behavioral equivalencies that can be associated with the listed indicia; assembling a list of indicia for which segment relevance can be measured; measuring the relevance for each indicia; measuring the relative degree to which the artifact as a whole is relevant to each segment; if the segment set contains sub-segments, repeat the process for each sub-segment. When analysis is complete, the system stores the generated evidence 1205. In regard to the pictured embodiment, a specific exemplary segment set is utilized. This ontology includes the following root classes: Shopping Segment 1210; News Segment 1211; Reference Segment 1212; Dining Segment 1213; Travel Segment 1214. Each segment would be comprised of one or more definitions that describe the manner and varieties of behaviors and interactions that a user would engage within the context of an associated artifact. Various embodiments can comprise various such sets and definitions.

1. A method, comprising:
retrieving, over a network, an artifact;
collecting, over the network, evidence associated with the artifact; and
selecting an artifact based on relevance to a set of categories based on information contained in the artifact.

2. The method of claim 1, wherein selecting an artifact is at least partially based on relevance to a set of categories based on external links to the artifact.

3. The method of claim 1, wherein selecting an artifact is at least partially based on relevance to a set of categories based on category selections made by an objective curator.

4. The method of claim 1, wherein selecting an artifact is at least partially based on relevance to a set of categories based on category selections made by a publisher, provider or creator of content.

5. The method of claim 1, wherein selecting an artifact is at least partially based on relevance to a set of categories based on information embedded in a document that is hidden during normal usage.

6. The method of claim 1, wherein the set of categories utilized comprises classes that are defined as sets of interactive behaviors.

7. The method of claim 1, wherein the set of categories utilized comprises classes that are defined as sets of expected interactive behaviors.

8. The method of claim 1, wherein the set of categories utilized comprises ontological classes that are defined as individual denotata.

9. The method of claim 1, wherein the set of categories utilized comprises ontological classes that are defined as individual types of content.

10. The method of claim 1, wherein the set of categories utilized are implemented as dimensional associations with each term of a query within the user interface of an information retrieval system.

11. The method of claim 1, wherein the set of categories utilized are implemented as dimensional associations with each term of a query where one or more terms or sets of terms are associated via a logical relationship or expression.

12. The method of claim 11, utilizing a logical operator “AND.”

13. The method of claim 11, utilizing a logical operator “OR.”

14. The method of claim 11, utilizing a logical operator “NOT.”

15. The method of claim 11, utilizing a logical intersection of one or more terms or set of terms.

16. The method of claim 11, utilizing a logical exclusion of one or more terms or set of terms.

17. The method of claim 11, utilizing logical union of one or more terms or set of terms.

18. The method of claim 11, utilizing a logical set difference of one or more terms or set of terms.

19. The method of claim 11, utilizing a logical symmetric difference of one or more terms or set of terms.

20. The method of claim 11, utilizing a logical Cartesian product of one or more terms or set of terms.

21. The method of claim 11, utilizing a logical power set of one or more terms or set of terms.

22. The method of claim 11, utilizing a logical Boolean conjunction of one or more terms or set of terms.

23. The method of claim 11, utilizing a logical Boolean disjunction of one or more terms or set of terms.

24. The method of claim 11, utilizing a logical Boolean negation of one or more terms or set of terms.

25. A method, comprising:
collecting, via a user interface, search terms within a search query, wherein the search terms are dimensionally-articulated.

26. The method of claim 25, wherein the dimensional articulation is at least partially based on relevance to a set of categories based on external links to the artifact.

27. The method of claim 25, wherein the dimensional articulation is at least partially based on relevance to a set of categories based on category selections made by an objective curator.

28. The method of claim 25, wherein the dimensional articulation is at least partially based on relevance to a set of categories based on category selections made by a publisher, provider or creator of content.

29. The method of claim 1, wherein the dimensional articulation is at least partially based on relevance to a set of categories based on information embedded in a document that is hidden during normal usage.

30. A method, comprising:
automatically selecting a specific search dimension association for at least one of a plurality of input terms within a dimensionally-articulated information retrieval system.

31. The method of claim 67, wherein articulation of at least one of the plurality of input terms is additionally articulated via a logical expression or operator.

32. The method of claim 31, wherein the logical operator or expression is automatically selected.
